(19) United States
(12) Patent Application Publication
(10) Pub. No.: US 2012/0095922 A1
(43) Pub. Date: Apr. 19, 2012

(54) IMAGE DATA SALES SYSTEM, IMAGE DATA SALES METHOD, CAMERA, AND SERVER APPARATUS

(75) Inventor: Toshiaki Wada, Tokyo (JP)

(73) Assignee: OLYMPUS IMAGING CORP., Tokyo (JP)

(21) Appl. No.: 13/269,784

(22) Filed: Oct. 10, 2011

(30) Foreign Application Priority Data
Oct. 18, 2010 (JP) 2010-233364

(51) Int. Cl. G06F 21/00; G06Q 30/06

(52) U.S. Cl. 705/51; 705/26.1

(57) ABSTRACT

In the present invention, a camera ID for specifying a camera that takes images to be sold is registered in a server in advance. The server issues an encryption key when the camera ID is registered, and the camera stores the encryption key and encrypts the camera ID by the encryption key to provide the camera ID to an image file including image data obtained by imaging. The server decrypts the encrypted camera ID provided to the image file transmitted from the user by a decryption key corresponding to the encryption key. If the camera ID obtained by the decryption coincides with the registered camera ID, the server authenticates that the image data included in the image file is imaged by the registered camera and discloses the image data to sell the image data.

### CROSS-REFERENCE TO RELATED APPLICATIONS

This application is based upon and claims the benefit of priority from the prior Japanese Patent Application No. 2010-233364, filed in Oct. 18, 2010, the entire contents of which are incorporated herein by reference.

### BACKGROUND OF THE INVENTION

1. Field of the Invention

The present invention relates to an image data sales system, an image data sales method, a camera, and a server apparatus.

2. Description of the Related Art

The number of photographs taken by a general camera user is increasing along with the proliferation of digital cameras. Due to the sophistication of the cameras, the general user can relatively easily obtain photographs with as good aesthetic quality as that of photographs taken by a professional cameraman.

Meanwhile, demands for photographic materials in homepage creation, etc., are also increasing along with the proliferation of the Internet. Services for connecting general camera users who wish to sell data of images taken by the general camera users are needed in response to the demands.

Although it is important that a purchaser of a sold image follow the copyright of the image, it is also important to confirm that the seller owns the copyright of the image data to be sold from the viewpoint of the copyright protection.

Japanese Patent Laid-Open No. 2000-125173 discloses a technique, in which a digital camera includes copyright data setting means, and a copyright data signal generated from the copyright data setting means is inserted as a digital watermark to image data to thereby protect the copyright of the camera user related to the image data.

From the standpoint of the user of the digital camera, the user checks copyright data embedded in the image data, and enhancement of the copyright protection of the image data of the imaged photograph can be expected in the technique of Japanese Patent Laid-Open No. 2000-125173.

However, in a service of receiving image data from the user of the digital camera and mediating sales of the image data, one of the technical problems is to confirm that the received image data is imaged by the user who has provided the image.

To mediate sales of image data by a member on an image service site, etc., it is essential to confirm that the seller of the image data owns the copyright of the image data for smooth and appropriate operation of the website, and it is desired to solve the technical problem.

An object of the present invention is to provide a simple method for verifying that image data provided by a sales requester is imaged by the sales requester.

### SUMMARY OF THE INVENTION

A first aspect of the present invention provides an image data sales system including a server apparatus that provides a service to a member through an information network and a camera registered in the server apparatus,

the camera including:

an imaging unit;

a camera ID memory that stores a camera ID for specifying the camera;

an encryption key memory that stores an encryption key distributed from the server apparatus by registering the camera ID in the server apparatus;

an image disclosure request generation unit that generates an image disclosure request including at least a member ID for identifying the member, image data imaged by the imaging unit, and an encrypted camera ID obtained by encrypting the camera ID by the encryption key stored in the encryption key memory; and

a first transmission unit that transmits the image disclosure request to the server apparatus through the information network,

the server apparatus including:

an encryption key generation unit that generates the encryption key and a corresponding decryption key corresponding to each camera ID of the camera registered by the member in the server apparatus;

a second transmission unit that transmits the generated encryption key to the camera with the registered camera ID;

a member management database that associates and registers at least the member ID, the camera ID of the camera registered by the member, and the decryption key generated by the encryption key generation unit;

an image disclosure determination unit that determines that the image data included in the image disclosure request can be disclosed if a second camera ID obtained by decrypting the encrypted camera ID included in the image disclosure request received from the camera through the information network by the decryption key registered in the member management database coincides with the camera ID registered in the member management database; and

an image disclosure unit that discloses the image data included in the image disclosure request determined to be able to be disclosed by the image disclosure determination unit as images to be sold through the information network.

A second aspect of the present invention provides an image data sales method for selling image data imaged by a camera through a server apparatus that provides a service to a member, the image data sales method including:

a first step by the server apparatus generating a pair of an encryption key and a decryption key corresponding to the camera registered by the member, distributing the encryption key to the camera, and associating and registering the decryption key, a member ID for identifying the member, and a camera ID for identifying the camera in a member management database;

a second step by the camera transmitting, to the server apparatus, an image disclosure request including at least the member ID, image data obtained by imaging a subject, and an encrypted camera ID obtained by encrypting the camera ID by the encryption key; and

a third step by the server apparatus disclosing the image data included in the image disclosure request through an information network and registering the image data in a sales image database to set the image data as image data that can be sold if it is determined that a second camera ID obtained by decrypting the encrypted camera ID included in the image disclosure request by the decryption key registered in the member management database coincides with the camera ID registered in the member management database.

A third aspect of the present invention provides an image data sales method for selling image data imaged by a camera through a server apparatus that provides a service to a member, the image data sales method including:

a first step by the server apparatus generating a pair of an encryption key and a decryption key corresponding to a camera ID for specifying the camera registered by the member, distributing the encryption key to the camera, and associating and registering the decryption key, a member ID for identifying the member, and the camera ID in a member management database;

a second step by the server apparatus receiving a registration of purchase request information including conditions of images to be purchased from an image purchase requester, storing the purchase request information in the purchase request database along with purchase request identification information for identifying the purchase request information, and disclosing the information through an information network that can be viewed from the camera;

a third step by the camera making a user select the disclosed purchase request information received from the server apparatus;

a fourth step by the camera transmitting, to the server apparatus, an image disclosure request including at least the purchase request identification information corresponding to the purchase request information selected by the user, the member ID, image data obtained by imaging a subject, and an encrypted camera ID obtained by encrypting the camera ID specific to the camera by the encryption key; and

a fifth step by the server disclosing the image data included in the image disclosure request to the image purchase requester specified by the purchase request identification information through the information network if it is determined that a second camera ID obtained by decrypting the encrypted camera ID included in the image disclosure request by the decryption key registered in the member management database coincides with the camera ID registered in the member management database.

A fourth aspect of the present invention provides a camera that is connected to a server apparatus, which provides a service to a member, through an information network to form an image data sales system, the camera including:

a communication unit that transmits and receives information to and from the server apparatus;

an image pickup unit that images a subject to output image data;

an identification information memory that stores a camera ID for specifying the camera;

an encryption key memory that stores an encryption key generated corresponding to the camera ID received from the server apparatus through the communication unit;

an encryption unit that encrypts the camera ID by the encryption key to generate an encrypted camera ID;

an image disclosure request generation unit that generates an image disclosure request including at least a member ID for specifying the member, the image data, and the encrypted camera ID; and

an image disclosure request transmission unit that transmits the image disclosure request to the server apparatus through the communication unit.

A fifth aspect of the present invention provides a server apparatus that provides a service to a member and that forms an image data sales system when a camera of the member is connected through an information network, the server apparatus including:

a communication unit that transmits and receives information to and from the camera;

a sales image database for registering image data to be sold transmitted from the camera;

an encryption key generation unit that generates an encryption key and a decryption key corresponding to a camera ID for specifying the camera transmitted from the camera and received through the communication unit;

a member management database that registers a member ID for identifying the member, a camera ID for identifying the camera, and a decryption key generated by the encryption key generation unit corresponding to the camera ID;

a camera registration unit that distributes the encryption key generated by the encryption key generation unit to the camera of a transmission source of the camera ID through the communication unit;

an image disclosure request reception unit that receives an image disclosure request including at least the member ID, the image data imaged by the camera, and an encrypted camera ID obtained by encrypting the camera ID by the encryption key through the communication unit;

a sales image data registration unit that registers the image data included in the image disclosure request in the sales image database if it is determined that a second camera ID obtained by decrypting the encrypted camera ID included in the image disclosure request by the decryption key registered in the member management database coincides with the camera ID registered in the member management database; and

a sales image disclosure unit that discloses the image data registered in the sales image database through the communication unit.

The present invention can provide a technique capable of verifying that image data provided by a sales requester is imaged by the sales requester.

### BRIEF DESCRIPTION OF THE DRAWINGS

FIG. 1 is a conceptual diagram showing an example of a configuration of an image data sales system for carrying out an image data sales method as an embodiment of the present invention;

FIG. 2 is a block diagram showing an example of configurations of an imaging apparatus and a server constituting the image data sales system as an embodiment of the present invention;

FIG. 3 is a block diagram showing an example of a configuration of an information terminal using the image data sales system as an embodiment of the present invention;

FIG. 4A is a conceptual diagram showing an example of a configuration of a sales image disclosure request generated by the imaging apparatus as an embodiment of the present invention;

FIG. 4B is a conceptual diagram showing another example of a configuration of the sales image disclosure request generated by the imaging apparatus as an embodiment of the present invention;

FIG. 5 is a conceptual diagram showing an example of configuration of a member management DB included in a service server as an embodiment of the present invention;

FIG. 6 is a conceptual diagram showing an example of configuration of a sales management DB included in the service server as an embodiment of the present invention;

FIG. 7 is a flow chart showing an example of a process of registering a camera in a server in the image data sales system as an embodiment of the present invention;

FIG. 8 is a flow chart showing an example of an imaging process by the camera as an embodiment of the present invention;

FIG. 9 is a flow chart showing an example of a process of registering sales image data from the camera to the server in the image data sales system as an embodiment of the present invention;

FIG. 10 is a flow chart showing an example of a disclosure process of sales images in the server constituting the image data sales system as an embodiment of the present invention;

FIG. 11 is a conceptual diagram showing an example of a configuration of sales image data generated by the imaging apparatus as another embodiment of the present invention;

FIG. 12 is a flow chart showing an example of an imaging process by the camera as another embodiment of the present invention;

FIG. 13 is a flowchart showing an example of a registration process of sales image data from the camera to a server in an image data sales system as another embodiment of the present invention;

FIG. 14 is a conceptual diagram showing an example of configuration of a server constituting an image data sales system as still another embodiment of the present invention;

FIG. 15 is a conceptual diagram showing an example of configuration of sales image data used in the image data sales system as still another embodiment of the present invention;

FIG. 16 is a conceptual diagram showing an example of configuration of a member management DB included in the server as still another embodiment of the present invention;

FIG. 17 is a conceptual diagram showing an example of configuration of a purchase management DB included in the server as still another embodiment of the present invention;

FIG. 18 is a conceptual diagram showing an example of configuration of a sales candidate management DB included in the server as still another embodiment of the present invention;

FIG. 19 is a flowchart showing an example of a registration process of a purchase request of image data from the information terminal to the server according to the present embodiment;

FIG. 20 is a flowchart showing an example of an importing process of sales image data from the camera to the information terminal in the image data sales system as still another embodiment of the present invention; and

FIG. 21 is a flowchart describing an example of a process of registering a sales image from the information terminal to the service server in the image data sales system as still another embodiment of the present invention.

### DESCRIPTION OF THE PREFERRED EMBODIMENT

In an aspect of the present embodiment, for example, a member registers a camera in advance and associates a camera ID as information for specifying the camera with a member ID as information for specifying the member to register the camera ID in a member management database of a service server. The service server generates an encryption key and a decryption key during the registration and associates the decryption key with the member ID to register the decryption key in the member management database. The service server transmits the generated encryption key to the camera to store the encryption key in the camera.

During imaging, the camera ID and imaging configuration information, such as imaging conditions, are encrypted by the encryption key stored in the camera. The camera ID and the imaging configuration information are included in a photographed image file and transmitted to the server as a sales image disclosure request. The server checks whether the camera ID decrypted by the decryption key coincides with the registered camera ID and checks whether there is no discrepancy in the imaging conditions recorded in the imaging configuration information as conditions for obtaining the photographed image data. The server discloses the photographed image data included in the sales image disclosure request as a sales image.

According to the present aspect, it can be confirmed that the photographed image data to be sold is imaged by the camera registered by the member, and an appropriate and smooth sales system of image data can be realized.

Embodiments of the present invention will now be described in detail with reference to the drawings. In the following description, a database is abbreviated as “DB”, and identification information is abbreviated as “ID”.

### First Embodiment

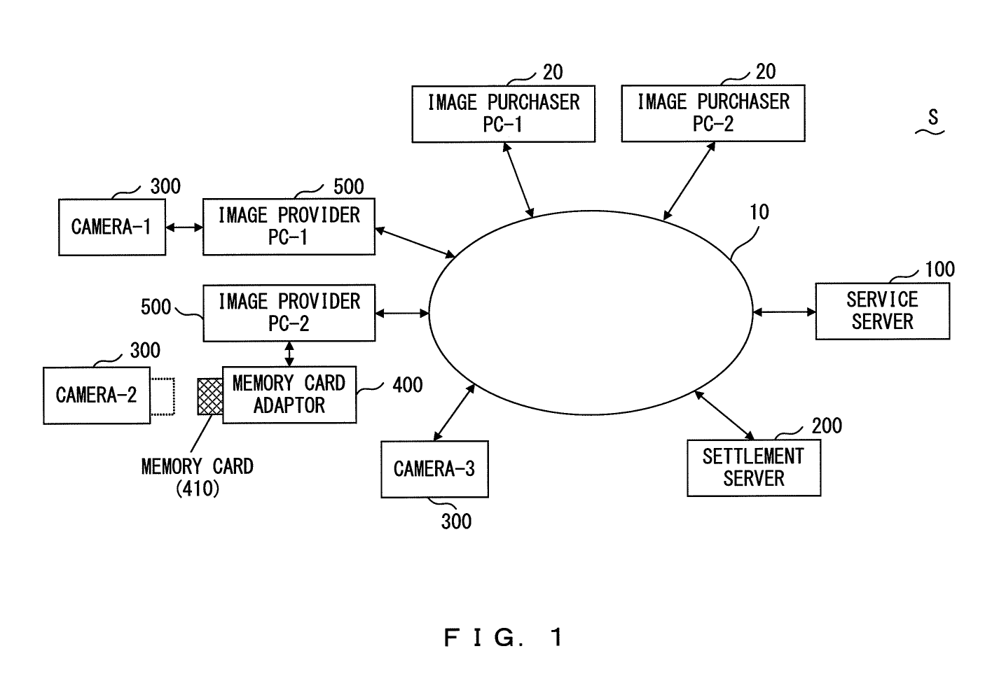

FIG. 1 is a conceptual diagram showing an example of a configuration of an image data sales system for carrying out an image data sales method as an embodiment of the present invention.

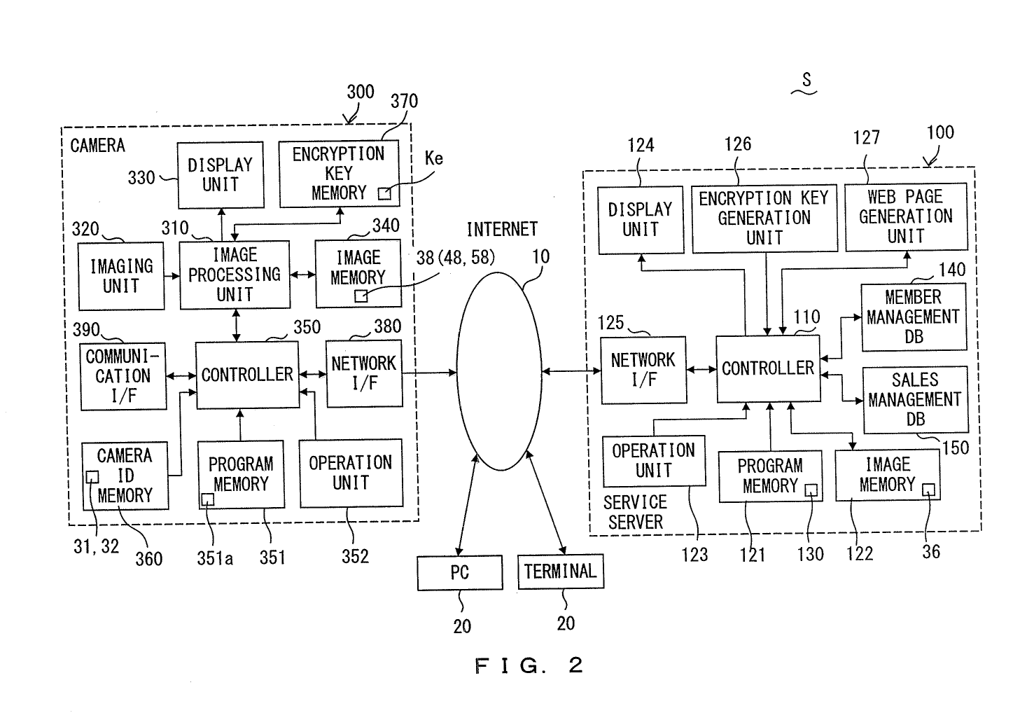

FIG. 2 is a block diagram showing an example of configurations of an imaging apparatus and a server constituting the image data sales system as an embodiment of the present invention.

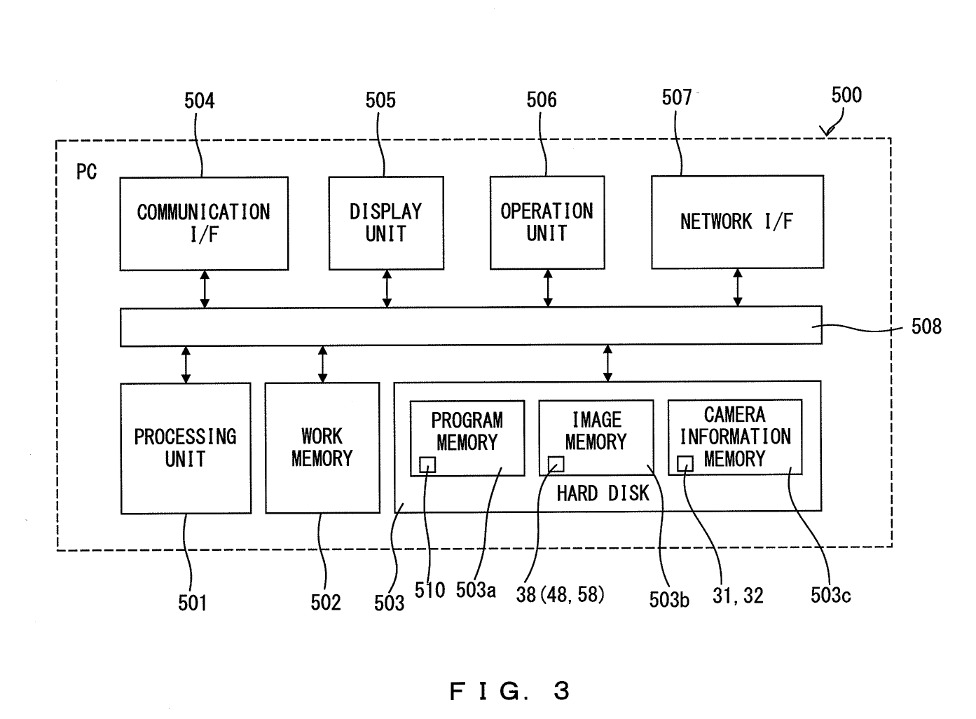

FIG. 3 is a block diagram showing an example of a configuration of an information terminal using the image data sales system as an embodiment of the present invention.

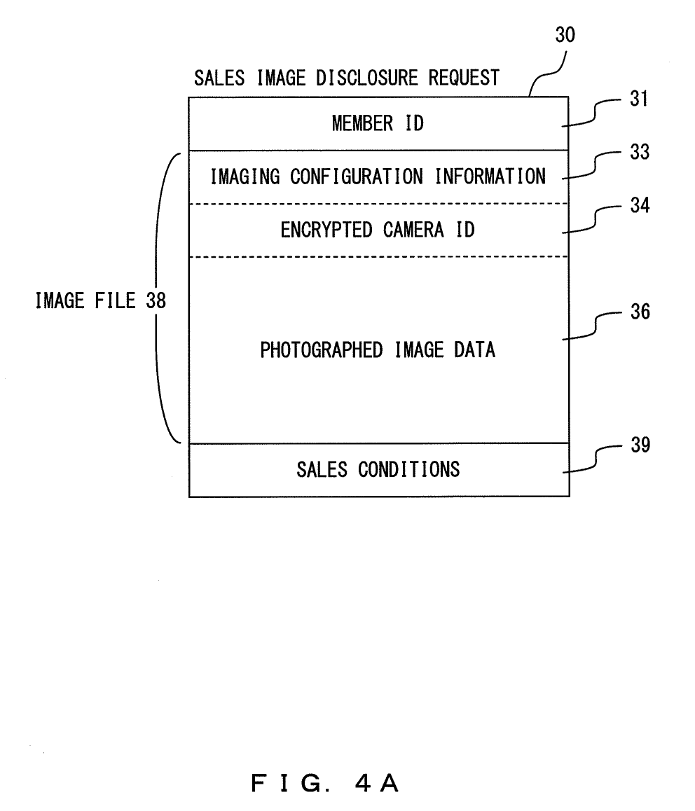

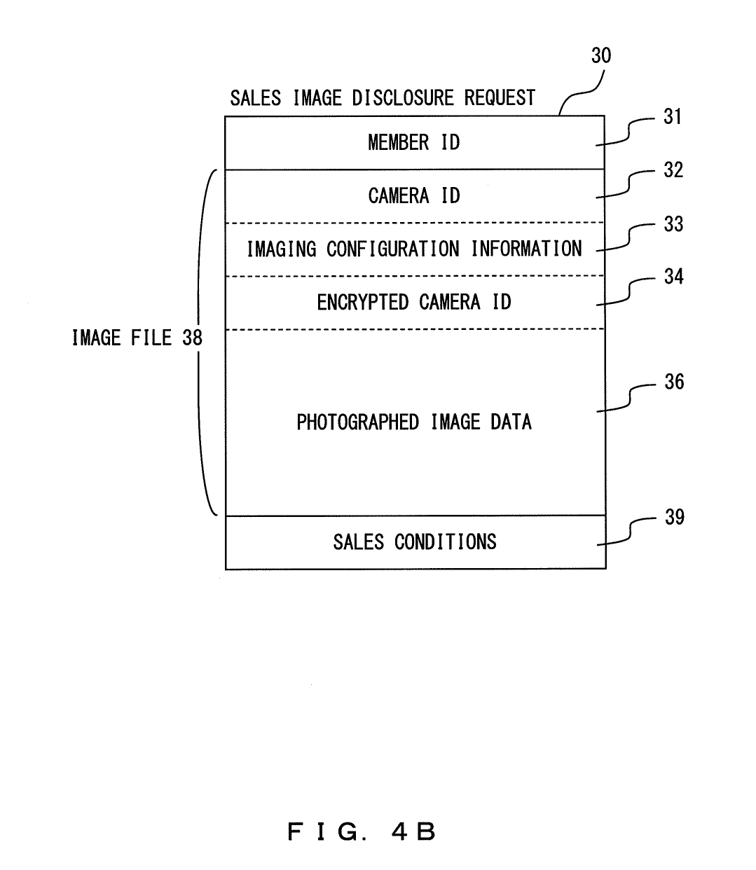

FIGS. 4A and 4B are conceptual diagrams showing examples of configurations of a sales image disclosure request generated by the imaging apparatus as an embodiment of the present invention.

As illustrated in FIG. 1, an image data sales system S of the present embodiment includes a service server 100 (server apparatus) and a camera 300 (imaging apparatus) connected to each other through a wide-range information network, such as an Internet 10 (information network).

The camera 300 is directly connected to the Internet 10 or indirectly connected to the service server 100 by being connected to an information terminal 500 connected to the Internet 10.

Transfer of information to and from the information terminal 500 is possible through a memory card 410 attached and detached to and from a memory card adaptor 400 included in the information terminal 500.

The image data sales system S can include a settlement server 200 connected to the Internet 10 for the settlement related to the sales of image data on an as needed basis as described later.

An information terminal 20, such as a personal computer, possessed by a purchaser of image data as described later is connected to the Internet 10.

As illustrated in FIG. 2, the service server 100 of the present embodiment includes a controller 110, a program memory 121, an image memory 122, an operation unit 123, a display unit 124, a network I/F (interface) 125, an encryption key generation unit 126 (encryption key generation means), a Web page generation unit 127, a member management DB 140, and a sales management DB 150.

The controller 110 executes control programs (sales image list disclosure means) (sales image data reception means) (imaging apparatus registration means) stored in the program memory 121 to control the entire operation of the service server 100 to realize control operations illustrated in flow charts described later.

The program memory 121 provides a storage area of the control programs and a work memory area used for the operation of the controller 110.

The image memory 122 holds photographed image data 36 (sales image data) received through the network I/F 125.

The operation unit 123 provides a user interface, such as a keyboard, for the manager of the service server 100 to control the service server 100.

The display unit 124 provides a user interface for displaying information for the manager of the service server 100 to monitor or operate the service server 100.

The network I /F 125 performs information communication with the Internet 10 under the control of the controller 110.

The encryption key generation unit 126 generates a pair of an encryption key Ke and a decryption key Kd corresponding to a camera ID 32 (imaging apparatus identification information) that is information for specifying the camera 300 received through the network I/F 125 as described later. As for the relationship between the encryption key Ke and the decryption key Kd, information encrypted by the encryption key Ke can be decrypted only by the decryption key Kd.

The Web page generation unit 127 generates a WEB page for disclosing image data to be sold through the Internet 10 as described later.

In the present embodiment, the controller 110 executes a control program 130 to register the camera ID 32 received through the network I/F 125 in a member management DB 160. The encryption key generation unit 126 generates the encryption key Ke and the decryption key Kd. The generated decryption key Kd is associated with the camera ID 32 and stored in the member management DB 160. The generated encryption key Ke is stored in the camera 300 of the transmission source of the camera ID 32. In this way, the control program 130 realizes imaging apparatus registration means for transmission through the network I/F 125.

The camera ID 32 received through the network I/F 125 may be a camera ID transmitted by the camera 300 directly connected to the Internet 10 as shown in FIG. 2, or the information terminal 500, to which the camera 300 is connected, may read out the camera ID 32 from a camera ID memory 360 of the camera 300 to transmit the camera ID 32 through the Internet 10 as shown in FIG. 1. In the latter case, the information terminal 500 receives the encryption key Ke transmitted by the service server 100 through the network I/F 125, and the encryption key Ke is stored in an encryption key memory 370 of the camera 300 connected to the information terminal 500.

Similarly, the control program 130 of the present embodiment realizes sales image data reception means for receiving a sales image disclosure request 30 through the network I/F 125. As shown in FIG. 4A, an example of the sales image disclosure request 30 includes a member ID 31 for specifying the member and at least one set of an image file 38 and sales conditions 39, and the camera 300 or the information terminal 500, to which the camera 300 is connected, generates the sales image disclosure request 30.

The image file 38 includes the photographed image data 36, an encrypted camera ID 34 that is obtained by encrypting the camera ID of the camera 300 that has taken the image by the encryption key Ke stored in the encryption key memory 370 of the camera 300, and imaging configuration information 33 that is information indicating the imaging situation during imaging of the photographed image data 36. The sales conditions 39 are sales conditions of the photographed image data 36 included in the corresponding image file 38.

The control program 130 of the present embodiment realizes decryption means for decrypting the encrypted camera ID 34 (encrypted imaging apparatus identification information) included in the image file 38 by the decryption key Kd registered in the member management DB specified by the member ID 31 included in the sales image disclosure request 30 received by the network I/F 125 through the sales image data reception means.

The control program 130 of the present embodiment further realizes comparison means for comparing the camera ID obtained by decrypting the encrypted camera ID 34 by the decryption means with the camera ID registered in the member management DB specified by the member ID 31 and realizes sales image data registration means for storing the photographed image data 36 included in the image file 38 in the image memory 122 and registering the sales conditions 39 in the sales management DB 150 if the decrypted camera ID coincides with the camera ID registered in the member management DB as a result of the comparison by the comparison means.

If the member registers a plurality of cameras, the camera ID 32 not encrypted may be included in the image file 38 in addition to the encrypted camera ID 34 as shown in FIG. 4B. The comparison means may specify the decryption key Kd registered in the member management DB 140 based on the member ID 31 and the camera ID 32 not encrypted and may decrypt the encrypted camera ID 34 by the specified decryption key Kd to compare the ID with the camera ID registered in the member management DB specified by the member ID 31. The comparison means may also compare the camera ID decrypted by the decryption key with the camera ID 32 not encrypted included in the image file 38.

The control program 130 of the present embodiment further realizes sales image list disclosure means for disclosing, as a Web page on the Internet 10 through the network I/F 125, a list of sales images which is a list of index images including the sales conditions 39 registered in the sales management DB 150 and the photographed image data 36 stored in the image memory 122.

The camera 300 of the present embodiment is made of, for example, a digital camera or a video camera and generates the photographed image data 36, such as still images and moving images with sound.

More specifically, as illustrated in FIG. 2, the camera 300 of the present embodiment includes an image processing unit 310, an imaging unit 320 (imaging means), a display unit 330, an image memory 340, a controller 350, a program memory 351, an operation unit 352, a camera ID memory 360 (identification information memory), an encryption key memory 370, a network I/F 380 (communication means), and a communication I/F 390.

In the imaging unit 320, an imaging element takes a subject image formed through an optical system and outputs an image signal.

The image processing unit 310 processes the image signal outputted by the imaging unit 320 to generate still image data or moving image data in a predetermined format.

In the present embodiment, the still image data in a predetermined format is, for example, image data in a JPEG format, and the moving image data in a predetermined format is, for example, image data in an MPEG format.

In the present embodiment, the imaging configuration information 33 includes, for example, imaging date/time, imaging device manufacturer name, imaging device model name, resolution of the entire photographed image data 36, resolution per unit in horizontal and vertical directions, imaging mode, shutter speed, aperture (F number), ISO sensitivity, photometric mode, presence/absence of flash, exposure correction step value, focal length of lens, subject distance, and color temperature. If the camera 300 is a camera with GPS, the imaging configuration information 33 further includes GPS information indicating latitude, longitude, altitude, etc., during imaging.

The camera ID memory 360 stores, for example, the camera ID 32 that is information, such as a serial number, specific to the camera 300. The camera ID memory 360 further stores the member ID 31 provided from the server in advance when the member is registered in the service server 100.

The encryption key memory 370 stores the encryption key Ke distributed from the service server 100 as described later.

The display unit 330 is a display that displays in real time a preview image of the subject imaged by the imaging unit 320 and displays various selection menus and operation information.

The operation unit 352 provides a user interface for the user to operate the camera 300, such as a release button, an operation switch, and a dial.

The network I/F 380 provides a wired or wireless function of connection with the Internet 10. The communication I/F 390 provides a wired or wireless function of connection with a communication I/F 504 of the information terminal 500.

More specifically, the camera 300 of the present embodiment can be used by an indirection connection with the Internet 10 through the information terminal 500 and can be used by a direct connection with the Internet 10 without the involvement of the information terminal 500.

The controller 350 includes a microprocessor, etc., that controls the entire camera 300 and executes a control program 351a (encryption means) stored in the program memory 351 to realize the following various controls.

More specifically, in the present embodiment, the control program 351a is executed by the controller 350 to realize imaging condition acquisition means for acquiring the imaging configuration information 33 of the imaging unit 320 and the image processing unit 310 during imaging of a subject.

Similarly, the control program 351a realizes encryption means for generating the encrypted camera ID 34 by encrypting the camera ID 32 by the encryption key Ke stored in the encryption key memory 370.

The control program 351a further realizes data storage means for associating the photographed image data 36 outputted by the image processing unit 310, the imaging configuration information 33 acquired by the imaging condition acquisition means, and the encrypted camera ID 34 obtained by encrypting the camera ID 32 stored in the camera ID memory 360 through the encryption means to generate the image file 38. The data storage means further stores the image file 38 in the image memory 340 and stores, in the image memory 340, the sales conditions 39 of the photographed image data inputted by the user operating the operation unit 352 of the camera 300 in association with the image file 38. The image file 38 may include the camera ID 32 not encrypted.

The control program 351a further realizes sales image disclosure request transmission means for transmitting the sales image disclosure request 30 including the member ID 31 stored in the camera ID memory 360 and the image file 38 as well as the sales conditions 39 read out from the image memory 340 to the service server 100 through the network I/F 380.

As illustrated in FIG. 3, the information terminal 500 of the present embodiment is constituted by, for example, a personal computer and has a function of accessing the service server 100 through the Internet 10.

More specifically, for example, a processing unit 501, a work memory 502, a hard disk 503, a communication I/F 504, a display unit 505, an operation unit 506, and a network I/F 507 are connected to the information terminal 500 through an information transmission path 508, and the components exchange information.

The processing unit 501 is, for example, a microprocessor. The work memory 502 is a main storage storing programs and data executed by the processing unit 501.

The hard disk 503 provides nonvolatile storage areas, such as a program memory 503a, an image memory 503b, and a camera information memory 503c.

The program memory 503a stores a control program 510 that is executed by the processing unit 501 to control the entire information terminal 500 and to realize operations illustrated in the flow charts described below.

The image memory 503b stores the image file 38 and the sales conditions 39 transferred from the camera 300 connected through the communication I/F 504.

The camera information memory 503c stores the member ID 31 received from the Internet 10 instead of the camera 300 or received from the connected camera 300.

The communication I/F 504 provides a connection function for information communication with the camera 300. Specifically, the communication I/F 504 includes a general-purpose wired connection interface such as a USB, a short-distance wireless communication interface, an infrared communication interface, etc.

The display unit 505 is made of a display that visualizes ad displays images and other information.

The operation unit 506 provides a user input function, such as keyboard and a pointing device.

The network I/F 507 provides a function of connection with the Internet 10.

More specifically, the information terminal 500 of the present embodiment is capable of executing a process of acquiring information, such as the image file 38 and the sales conditions 39, from the camera 300 connected through the communication I/F 504, storing the information in the image memory 503b, generating the sales image disclosure request 30 including the image file 38, the sales conditions 39, and the member ID 31 stored in the camera information memory 503c in place of the camera 300, and transmitting the sales image disclosure request 30 to the service server 100.

The member management DB 140 and the sales management DB 150 included in the service server 100 will be described.

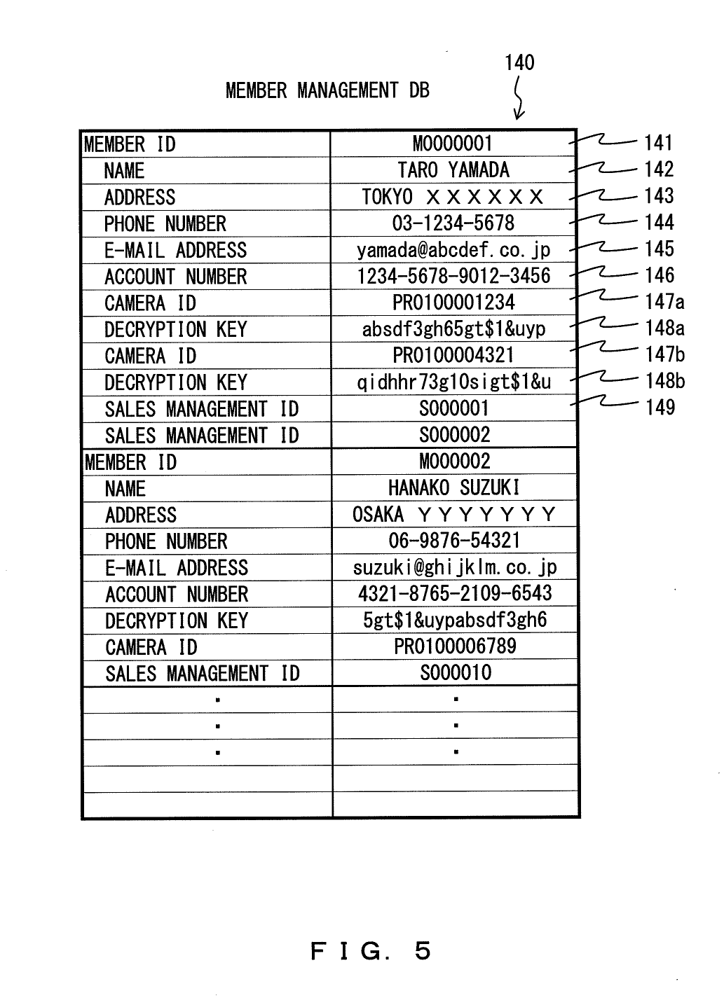

FIG. 5 is a conceptual diagram showing an example of configuration of the member management DB 140 included in the service server of the present embodiment.

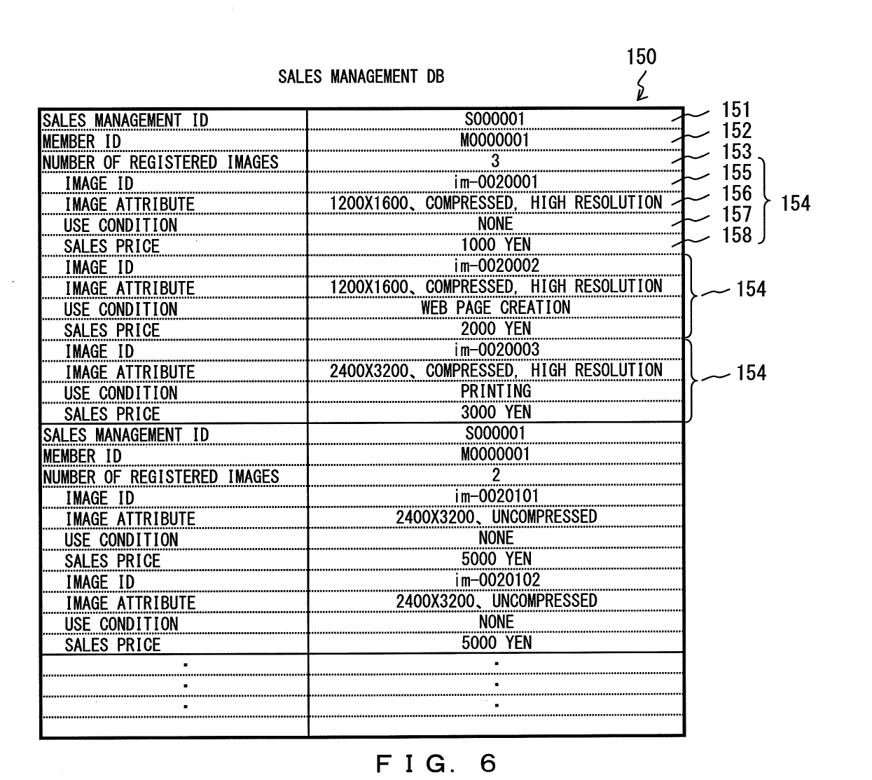

FIG. 6 is a conceptual diagram showing an example of configuration of the sales management DB 150 included in the service server of the present embodiment.

As illustrated in FIG. 5, the member management DB 140 of the present embodiment includes a member ID field 141, a name field 142, an address field 143, a phone number field 144, an E-Mail address field 145, an account number field 146, a camera ID field 147X, a decryption key field 148X, and a sales management ID field 149 (147X denotes 147a, 147b, . . . , and 148X denotes 148a, 148b, . . . ).

The member ID as identification information uniquely allocated to the owner of the registered camera 300 is registered in the member ID field 141.

The name of the member, address, phone number, E-Mail address, and account number of settlement account that are personal information of the member are registered in the name field 142, the address field 143, the phone number field 144, the E-Mail address field 145, and the account number field 146, respectively.

The camera ID for specifying the camera 300 registered by the member is registered in the camera ID field 147X.

The encryption key Ke that is generated during the device registration corresponding to the camera 300 specified by the camera ID registered in the camera ID field 147X and that is transmitted to the camera 300 and the decryption key Kd generated in combination with the encryption key Ke are registered in the decryption key field 148X. If a plurality of cameras are registered for the same member, the decryption key Kd generated corresponding to the camera ID registered in each camera ID field 147X is registered in the decryption key field 148X.

Information (sales management ID described later) for identifying image sales information disclosed corresponding to the sales image disclosure request 30 registered in the sales management DB 150 described later is registered in the sales management ID field 149.

Meanwhile, as illustrated in FIG. 6, the sales management DB 150 of the present embodiment includes a sales management ID field 151, a member ID field 152, a number of registered images field 153, and an image sales information field 154.

A sales management ID as identification information uniquely allocated for managing the image sales is registered in the sales management ID field 151. As described later, the sales management ID is generated and registered in the sales management ID field when it is determined that the photographed image data 36 included in the sales image disclosure request 30 transmitted from the member is an image taken by the camera registered by the member.

The member ID 31 of the member who has registered the image sales information corresponding to the sales management ID is registered in the member ID field 152.

An amount of the registered photographed image data 36 to be sold is registered in the number of registered images field 153.

Each image sales information field 154 includes an image ID field 155, an image attribute field 156, a use condition field 157, and a sales price field 158.

The image ID as information for identifying the individual photographed image data 36 stored in the image memory 122 is registered in the image ID field 155. Information indicating attributes of image, such as the size and compression state of the photographed image data 36 and the image quality, is registered in the image attribute field 156. The attributes of image are included in the imaging configuration information 33 of the image file 38 of the sales image disclosure request 30.

Information for limiting the usage by the purchaser who has purchased the photographed image data 36 is registered in the use condition field 157.

For example, if the use condition field 157 indicates “WEB PAGE CREATION”, the purchaser can use the purchased image only for the Web page creation. If the use condition field 157 indicates “PRINTING”, the purchaser can use the purchased image only for printing and viewing. If the use condition field 157 indicates “NONE”, the purchaser can freely use the purchased image.

The sales price of the photographed image data 36 is registered in the sales price field 158. The information registered in the use condition field 157 and the sales price field 158 is information included in the sales conditions 39 of the sales image disclosure request 30.

An example of an operation of the present embodiment will be described with reference to a flow chart.

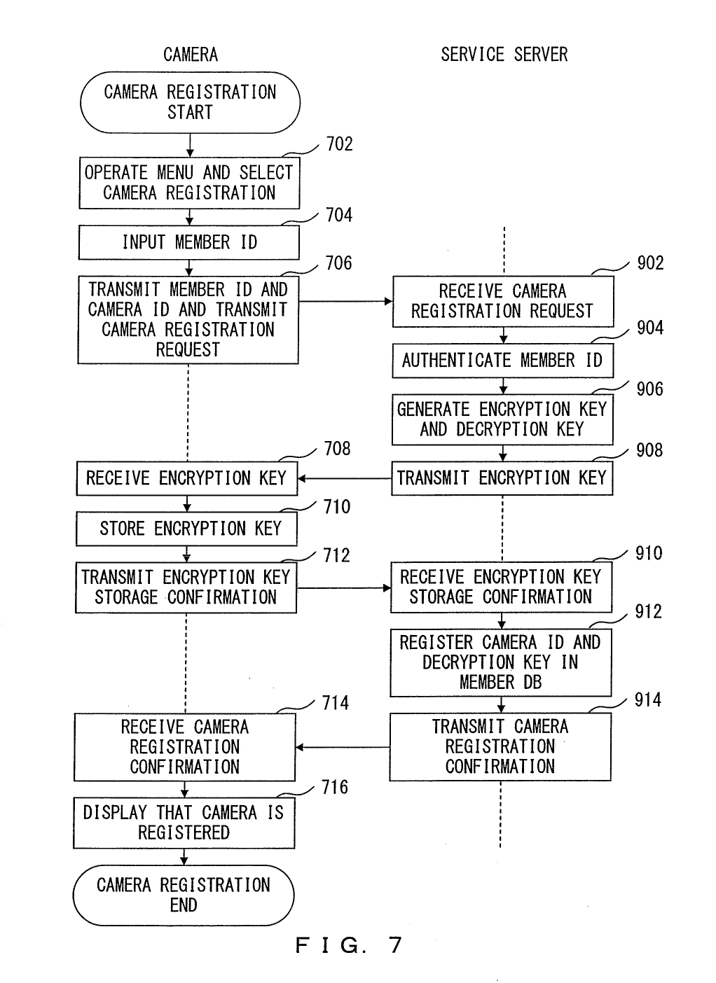

FIG. 7 is a flow chart showing an example of a process of registering the camera 300 in the service server 100 in the image data sales system of the present embodiment.

In the camera registration process illustrated in FIG. 7, the camera 300 displays a menu on the display unit 330 and receives a selection input of the camera registration by an operation of the menu by the user (step 702).

The camera 300 further receives an input of the member ID 31 from the user (step 704) and transmits a camera registration request including the member ID 31 and the camera ID 32 read out from the camera ID memory 360 to the service server 100 (step 706). (It is assumed in the present embodiment that the user has registered the membership for using the service provided by the service server 100, personal information of the user, such as name and address, has been registered in the member management DB 140 during the membership registration, and the service server 100 has issued the member ID.)

When the camera registration request from the camera 300 is received (step 902), the service server 100 authenticates the member ID 31 (step 904), generates the encryption key Ke and the decryption key Kd (step 906), and transmits the encryption key Ke to the camera 300 (step 908 (first step)).

Although not illustrated, if the camera ID 32 is already registered in the member DB after the authentication of the member ID 31 in step 904, a notification indicative of the completion of the registration of the camera 300 is transmitted to the camera 300, and the camera 300 receives the notification to display the notification on the display unit 330 to end the camera registration process.

When the encryption key Ke is received from the service server 100 (step 708), the camera 300 stores the encryption key Ke in the encryption key memory 370 (step 710) and transmits an encryption key storage confirmation to the service server 100 (step 712).

When the encryption key storage confirmation is received from the camera 300 (step 910), the service server 100 registers the camera ID 32 and the decryption key Kd in the camera ID field 147X and the decryption key field 148X of the member management DB 140, respectively (step 912), and transmits the camera registration confirmation to the camera 300 (step 914).

When the camera registration confirmation from the service server 100 is received (step 714), the camera 300 stores the member ID 31 inputted in step 704 in the camera ID memory 360 and displays on the display unit 330 the registration of the camera 300 in the service server 100 to notify the user of the registration (step 716).

In this way, the process of registering the camera 300 in the service server 100 is completed.

Although the member ID 31 is used in the authentication process when the camera 300 is connected to the service server 100, the member ID 31 is stored in the camera ID memory 360 by the registration of the camera 300. Therefore, there is no need to operate the operation unit 352 to input the member ID 31 every time the camera 300 is connected to the service server 100.

An imaging process in the camera 300 after the registration in the service server 100 will be described.

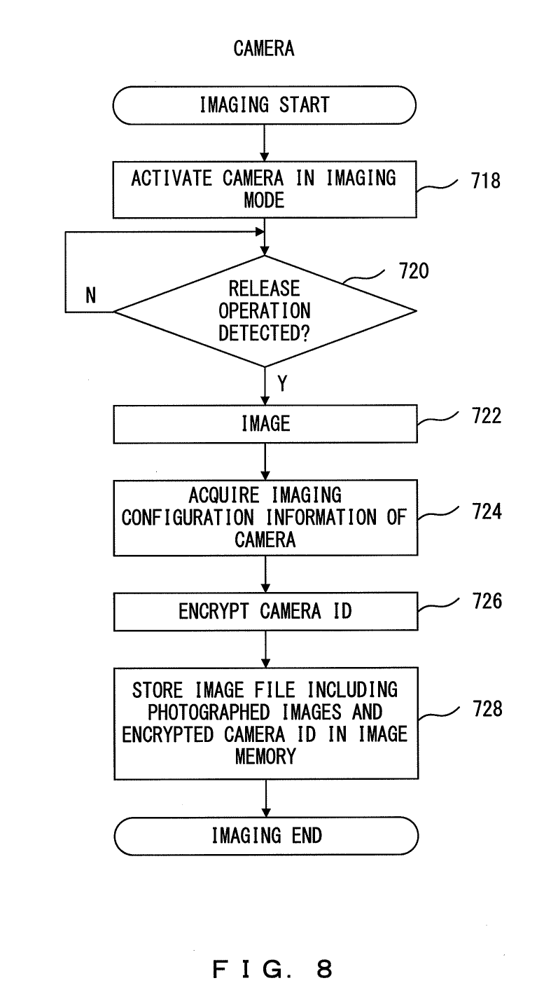

FIG. 8 is a flow chart showing an example of the imaging process by the camera of the present embodiment.

When the camera 300 is activated in an imaging mode by an operation of the operation unit 352 by the user (step 718), the controller 350 of the camera 300 monitors a release operation of the operation unit 352 by the user (step 720). An image is taken when the release operation is detected, and photographed image data is generated (step 722).

The controller 350 of the camera 300 collects the imaging configuration information 33 related to the photographed image data 36 (step 724).

The controller 350 of the camera 300 uses the encryption key Ke stored in the encryption key memory 370 to encrypt the camera ID 32 read out from the camera ID memory 360 (step 726). The controller 350 adds the camera ID 32 to the imaging configuration information 33 and the photographed image data 36 to create the image file 38 including the encrypted camera ID 34 encrypted by the encryption key Ke and stores the image file 38 in the image memory 340 (step 728).

A process of transmitting the sales image disclosure request 30 including the image file 38 created by the camera 300 to the service server 100 to disclose the request will be described.

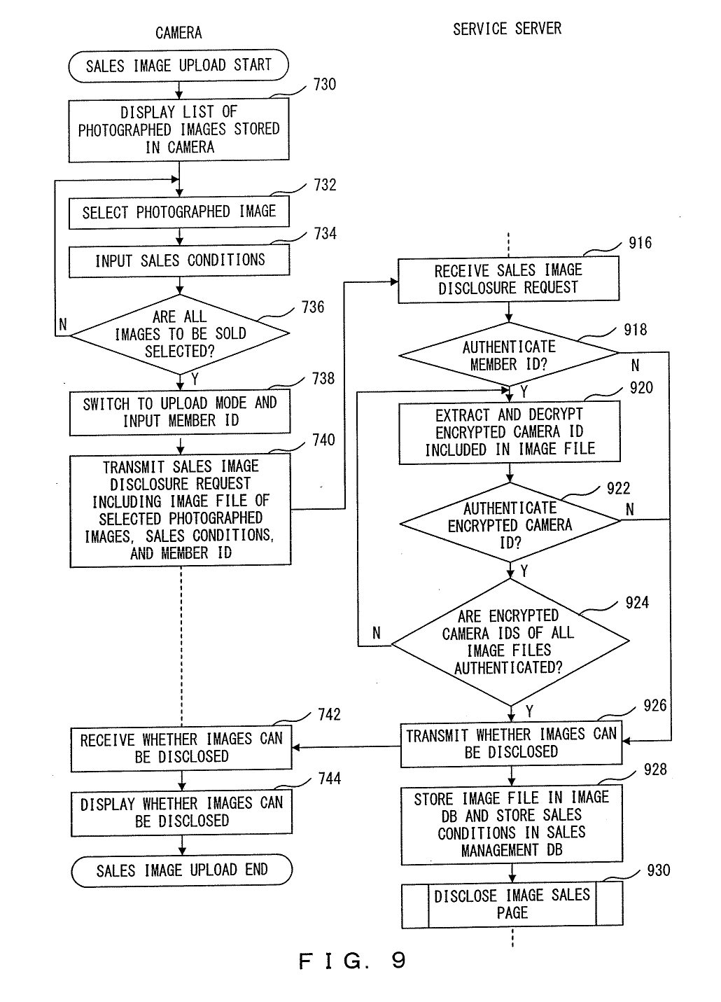

FIG. 9 is a flow chart showing an example of a registration process of sales information of an image from the camera 300 to the service server 100 in the image data sales system of the present embodiment.

As illustrated in FIG. 9, upon the start of the upload of the sales image disclosure request 30 from the camera 300 to the service server 100 to sell images, the camera 300 displays, on the display unit 330, a list of the photographed image data 36 in the image file 38 stored in the image memory 340 (730). The camera 300 receives a selection of the photographed image data 36 by the user (step 732) and receives an input of the sales conditions 39 of the selected photographed image data 36 (step 734).

Whether the selection of the photographed image data 36 that the user wants to sell and the input of the sales conditions in steps 732 and 734 are completed is determined from a user input (step 736). If the selection of the photographed image data and the input of the sales conditions are completed, the camera 300 is switched to an upload mode, and an input of the member ID 31 is received from the user (step 738). If the member ID 31 is stored in the camera ID memory 360, the member ID 31 may be read out from the camera ID memory 360 in step 738.

The sales image disclosure request 30, in which the member ID 31 is added to the image file 38 including the photographed image data 36 selected by the user and added to the sales conditions 39 inputted by the user, is transmitted to the service server 100 (step 740 (second step)).

When the sales image disclosure request 30 is received from the camera 300 (step 916), the service server 100 authenticates the member ID 31 (step 918). If the authentication is successful, the service server 100 extracts the encrypted camera ID 34 in the image file 38 included in the sales image disclosure request 30 to decrypt the encrypted camera ID 34 by the decryption key Kd stored in the member management DB specified by the member ID 31 (step 920) and determines whether the decrypted camera ID coincides with the camera ID registered in the camera ID field 147X of the member management DB 140 (step 922).

If a plurality of camera IDs are registered in the camera ID field specified by the member ID 31, the camera ID 32 not encrypted maybe added to the sales image disclosure request 30 transmitted from the camera 300 in addition to the encrypted camera ID 34, and the decryption key Kd maybe specified by the member ID 31 included in the sales image disclosure request 30 and the camera ID 32 not encrypted to determine whether the camera ID obtained by decrypting the encrypted camera ID 34 by the decryption key Kd coincides with the camera ID registered in the camera ID field 147X of the member management DB 140. Whether the camera ID obtained by decrypting the encrypted camera ID 34 by the decryption key Kd coincides with the camera ID 32 not encrypted included in the sales image disclosure request 30 may also be determined.

After the authentication of the encrypted camera IDs 34 of all image files 38 included in the sales image disclosure request 30 in steps 920 and 922 (step 924), whether the images can be disclosed is transmitted to the camera 300 (step 926).

If the authentication of the member ID 31 has failed in step 918 or if the authentication of the encrypted camera IDs 34 has failed in step 922, information for notifying that the disclosure is not allowed is transmitted to the camera 300 in step 926. If the member ID 31 and the encrypted camera IDs 34 of all image files 38 are authenticated, information for notifying that the disclosure is allowed is transmitted to the camera 300.

After the transmission of whether the images can be disclosed, the service server 100 stores, in the image memory 122, the photographed image data 36 included in the sales image disclosure request 30 that can be disclosed and registers the sales conditions 39 in the sales management DB 150 (step 928). The service server 100 creates a WEB page of the image sales indicating index images of the photographed image data 36 and the sales conditions and discloses the WEB page on the Internet 10 through the network I/F 125 (step 930 (third step)).

Meanwhile, after receiving whether the images can be disclosed from the service server 100 in step 926 (step 742), the camera 300 displays whether the images can be disclosed on the display unit 330 to notify the user (step 744).

In this way, the upload of the sales image disclosure request 30 including the photographed image data 36 to be sold from the camera 300 to the service server 100 is completed.

An example of a disclosure process of the sales images in the service server 100 of the present embodiment will be described.

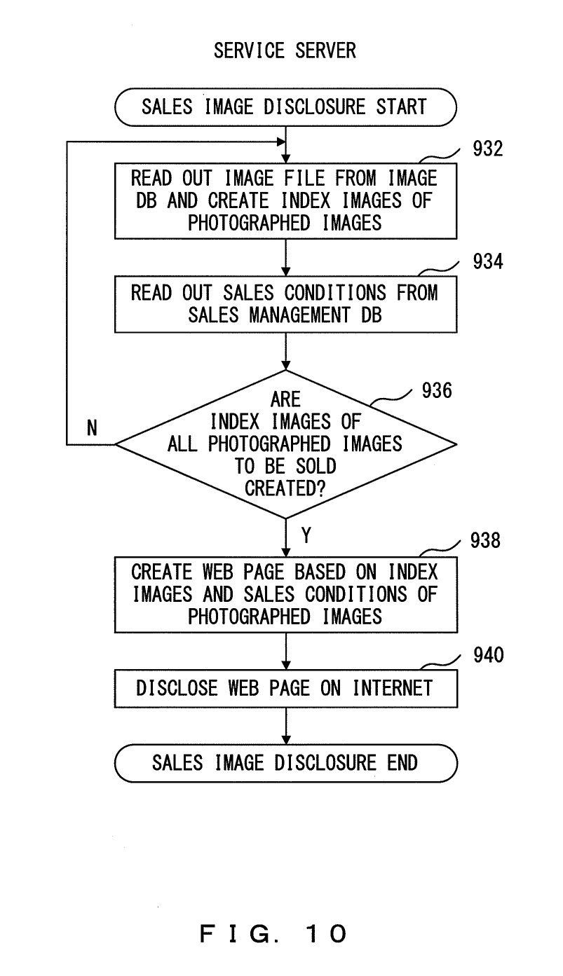

FIG. 10 is a flow chart showing an example of the disclosure process of the sales images in the server constituting the image data sales system of the present embodiment.

More specifically, the flow chart of FIG. 10 illustrates details of step 930 in FIG. 9.

Upon the disclosure of the sales images, the service server 100 reads out the photographed image data 36 to be disclosed from the image memory 122 to reduce the photographed images to create index images (step 932) and reads out the sales conditions corresponding to the photographed image data 36 to be disclosed from the sales management DB 150 (step 934). The service server 100 repeats the process until the index images of all photographed images to be sold are created (step 936).

The service server 100 then creates a WEB page based on the generated index images of the photographed image data 36 and the sales conditions 39 (step 938) and discloses the WEB page on the Internet 10 (step 940).

Although not particularly illustrated, if a purchase operation to the photographed image data 36 is performed on the disclosed WEB page, the service server 100 transmits the photographed image data 36 purchased through the Internet 10 to the information terminal 20 possessed by the purchase requester. The settlement server 200 executes a settlement process, such as withdrawing the sales price from the account of the purchaser and transferring the sales price to the account of the owner of the photographed image data 36.

In the present embodiment, the seller of the images and the purchasers of the images are registered as members in the service server 100, and the account numbers for the settlement are registered in the member management DB 140.

In this way, in the image data sales system S of the present embodiment, the encryption key Ke of the encryption key Ke and the decryption key Kd generated corresponding to the camera ID 32 specific to the camera 300 is distributed to the camera 300 registered in advance.

The camera 300 adds the sales conditions 39 of the photographed image data 36 to the image file 38 including the photographed image data 36 imaged by the camera 300, the imaging configuration information 33, as well as the encrypted camera ID 34 obtained by encrypting the camera ID 32 by the encryption key Ke and further transmits the sales image disclosure request 30 with the member ID 31 to the service server 100. The service server 100 decrypts the encrypted camera ID 34 by the decryption key Kd corresponding to the member ID 31 and determines whether the photographed image data 36 is imaged by the camera 300 based on the match/mismatch with the camera ID registered in the camera ID field 147X of the member management DB 140.

If the member who wishes to sell the images registers a plurality of cameras, the camera ID 32 not encrypted as well as the encrypted camera ID 34 may be added to the sales image disclosure request 30 to be transmitted from the camera 300, and the decryption key Kd may be specified from the member ID 31 and the camera ID 32 not encrypted included in the sales image disclosure request 30 to determine whether the camera ID obtained by decrypting the encrypted camera ID 34 by the encryption key Kd coincides with the member ID registered in the camera ID field 147X of the member management DB 140. Whether the camera ID obtained by decrypting the encrypted camera ID 34 by the decryption key Kd coincides with the camera ID 32 not encrypted included in the sales image disclosure request 30 may also be determined.

As described, the image data sales system S of the present embodiment can surely confirm that the photographed image data 36 is imaged by the camera 300 registered by the member as a sales requester of images and can surely prevent inappropriate sales actions of the photographed image data 36 by the owner of the camera 300, such as selling the photographed image data 36 of another person as data imaged by the camera 300 of the owner.

When the photographed image data 36 and the encrypted camera ID 34 are included in one image file 38, a digital watermark composition function may be provided to the camera 300, and the encrypted camera ID 34 may be included as a digital watermark of the photographed image data 36. In this case, since the photographed image data 36 and the encrypted camera ID cannot be separated, the system can more surely confirm that the photographed image data 36 is imaged by the camera 300 registered by the member.

As a result, the image data sales system S of the present embodiment can verify that the photographed image data 36 provided from the sales requester is imaged by the camera 300 possessed by the sales requester to realize appropriate and smooth sales of the photographed image data 36.

### Second Embodiment

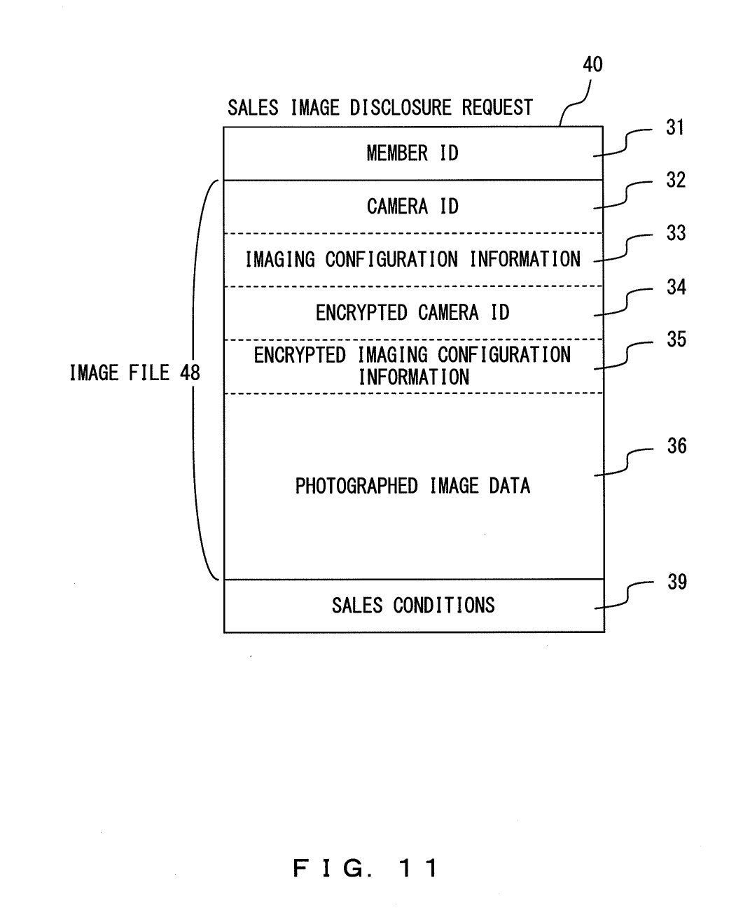

An example of encrypting and including both the camera ID 32 and the imaging configuration information 33 in an image file 48 of a sales image disclosure request 40 for use in the authentication will be illustrated as another embodiment of the present invention (FIG. 11).

The system configuration is similar to that in the first embodiment, and differences will be described.

In addition to the functions illustrated in the first embodiment, the control program 351a of the camera 300 realizes encryption means for encrypting the imaging configuration information 33 by the encryption key Ke stored in the encryption key memory 370 to generate encrypted imaging configuration information 35.

In addition to the functions illustrated in the first embodiment, the control program 351a further realizes data storage means for associating the photographed image data 36 outputted by the image processing unit 310, the camera ID 32 stored in the camera ID memory 360, the imaging configuration information 33 acquired by the imaging condition acquisition means, and the encrypted camera ID 34 and the encrypted imaging configuration information 35 respectively obtained by encrypting the camera ID 32 and the imaging configuration information 33 by the encryption means and storing the information in the image memory 340 as the image file 48.

In addition to the functions of the first embodiment, the control program 130 of the service server 100 of the present second embodiment realizes decryption means for decrypting the encrypted imaging configuration information 35 included in the image file 48 of the sales image disclosure request 40 received by the sales image data reception means by the decryption key Kd specified by the member ID 31 and the camera ID 32 registered in the member management DB 140.

In addition to the functions of the first embodiment, the control program 130 of the present embodiment further realizes comparison means for comparing the imaging configuration information obtained by the decryption by the decryption means with the imaging configuration information 33 not encrypted included in the image file 48 of the received sales image disclosure request 40 and realizes sales image data registration means for storing the photographed image data 36 included in the image file 48 in the image memory 122 to register the information of the sales conditions 39 in the sales management DB 150 if the decrypted imaging configuration information coincides with the imaging configuration information 33 not encrypted as a result of the comparison by the comparison means. The Web page generation unit 127 creates a WEB page including index images of the photographed image data and the sales conditions and discloses the WEB page on the Internet.

More specifically, the service server 100 discloses the photographed image data 36 and the sales conditions 39 on the Internet in the second embodiment when authentications of both the camera ID 32 and the imaging configuration information 33 are successful.

FIG. 11 is a conceptual diagram showing an example of a configuration of sales image data generated by the imaging apparatus as the second embodiment of the present invention.

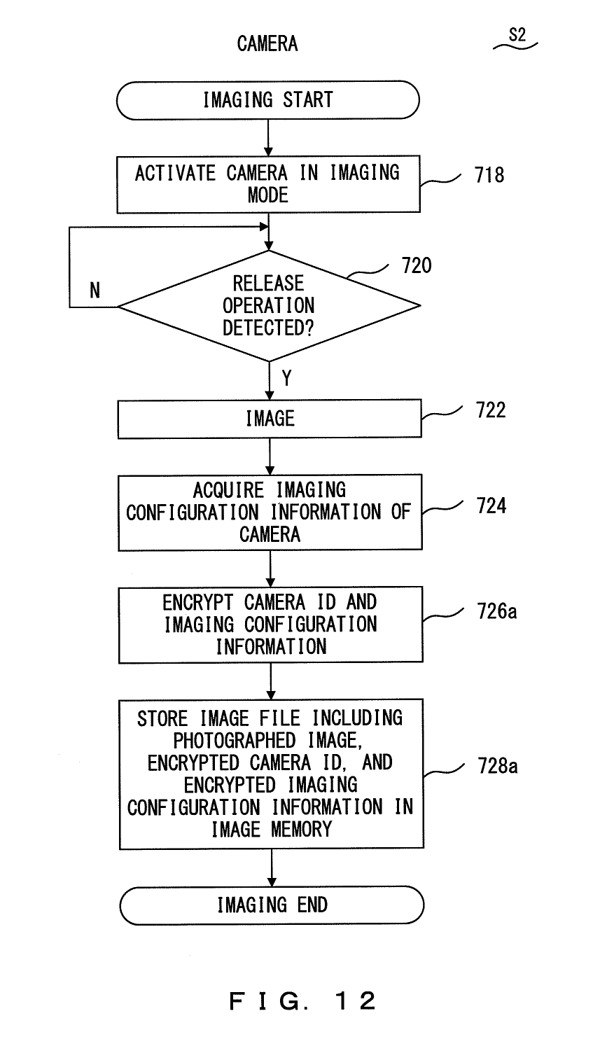

FIG. 12 is a flow chart showing an example of an imaging process by the camera as the second embodiment of the present invention.

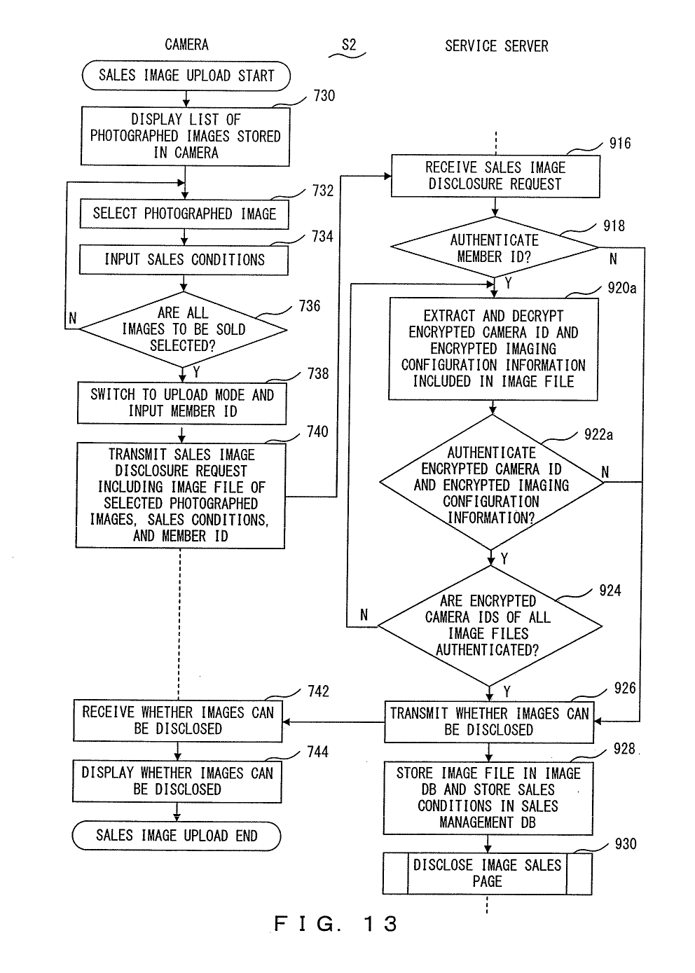

FIG. 13 is a flow chart showing an example of a process of registering the sales image data from the camera to the server in the image data sales system as the second embodiment of the present invention.

In the second embodiment, the encrypted imaging configuration information 35 encrypted by the encryption key Ke is added to the image file 48 included in the sales image disclosure request 40 as illustrated in FIG. 11.

More specifically, in the flow chart of FIG. 12 of the present second embodiment corresponding to FIG. 8 of the first embodiment, the camera 300 uses the encryption key Ke stored in the encryption key memory 370 to encrypt the camera ID 32 and the imaging configuration information 33 (step 726a) and stores, in the image memory 340, the image file 48 including the camera ID 32, the imaging configuration information 33, the photographed image data 36, the encrypted camera ID 34, and the encrypted imaging configuration information 35 (step 728a).

Accordingly, in the flow chart of FIG. 13 of the present second embodiment corresponding to FIG. 9 of the first embodiment, after receiving the sales image disclosure request 40 from the camera 300 (step 916), if the authentication of the member ID 31 is successful (step 918), the service server 100 extracts the encrypted camera ID 34 and the encrypted imaging configuration information 35 included in the image file 48 of the sales image disclosure request 40 to decrypt the encrypted camera ID 34 and the encrypted imaging configuration information 35 by the decryption key Kd registered in the decryption key field 148X corresponding to the member ID 31 and the camera ID 32 not decrypted (step 920a) and determines whether the decrypted camera ID and the decrypted imaging configuration information coincide with the camera ID 32 not encrypted and the imaging configuration information 33, respectively (step 922a).

In this way, in an image data sales system S2 of the present second embodiment, the camera 300 includes, in the image file 48, the encrypted camera ID 34 and the encrypted imaging configuration information 35 obtained by encrypting the camera ID 32 and the imaging configuration information 33 by the encryption key Ke in addition to the photographed image data 36 imaged by the camera 300, the camera ID 32, and the imaging configuration information 33 and transmits the sales image disclosure request 40 to the service server 100 along with the member ID 31 and the sales conditions 39. The service server 100 decrypts the encrypted camera ID 34 and the encrypted imaging configuration information 35 included in the image file 48 by the decryption key Kd corresponding to the member ID 31 and the camera ID 32 included in the image file 48 and determines whether the photographed image data 36 is imaged by the camera 300 based on the match/mismatch of the camera ID 32 and the imaging configuration information 33. In step 922a, the decrypted camera ID may be compared with the camera ID registered in the camera ID field 147X of the member management DB 140 specified by the member ID 31 included in the sales image disclosure request 30.

Therefore, the image data sales system S2 of the present embodiment can more surely confirm that the photographed image data 36 is imaged by the camera 300 registered by the member as the seller, compared to when only the encrypted camera ID 34 is used as in the first embodiment, and can surely prevent inappropriate sales actions of the photographed image data 36, such as the owner of the camera 300 selling the photographed image data 36 of another person as data imaged by the camera 300 of the owner. More specifically, the imaging configuration information is information linked to the photographed image data, and the imaging configuration information is different in each imaging. Therefore, the photographed images can be more reliably confirmed as images taken by the registered camera.

The agent of the sales of the images can visually observe the photographed images to check whether there is a discrepancy between the imaging configuration information and the photographed image data to determine whether the photographed image data 36 is imaged by the camera 300 specified by the camera ID 32. For example, if the photographed image shows a landscape and the subject distance (distance from the camera to the focused subject) as the imaging configuration information is 1 meter, it is determined that the photographed image data 36 in the image file 48 is falsified.

When the photographed image data 36, the encrypted camera ID 34, and the encrypted imaging configuration information 35 are included in one image file 48, a digital watermark composition function may be provided to the camera 300, and the encrypted camera ID 34 and the encrypted imaging configuration information 35 may be included as digital watermarks of the photographed image data 36. Since the encrypted camera ID and the encrypted imaging configuration information 35 cannot be separated from the photographed image data 36, it can be more surely confirmed that the photographed image data 36 is imaged by the camera 300 registered by the member.

### Third Embodiment

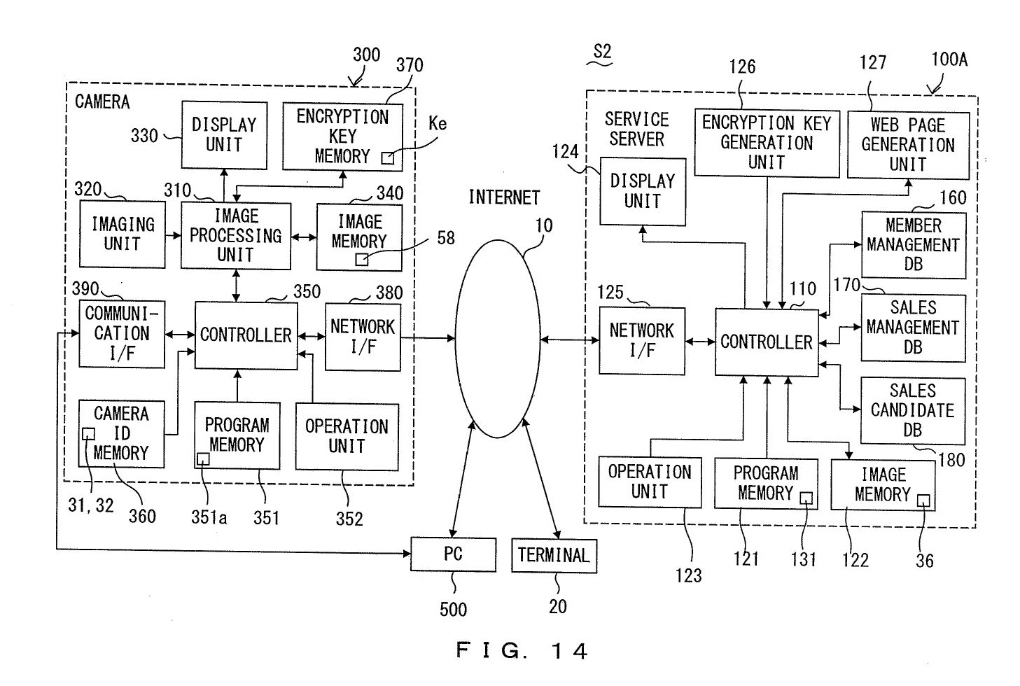

FIG. 14 is a conceptual diagram showing an example of configuration of a server that constitutes an image data sales system S3 as a third embodiment of the present invention.

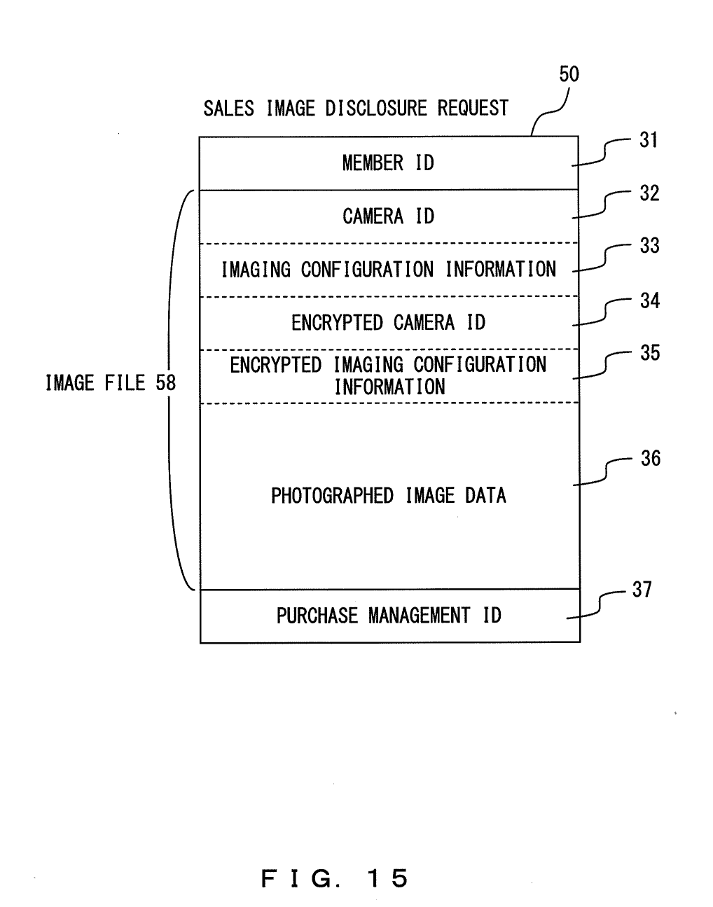

FIG. 15 is a conceptual diagram showing an example of configuration of sales image data used in the image data sales system of the present third embodiment.

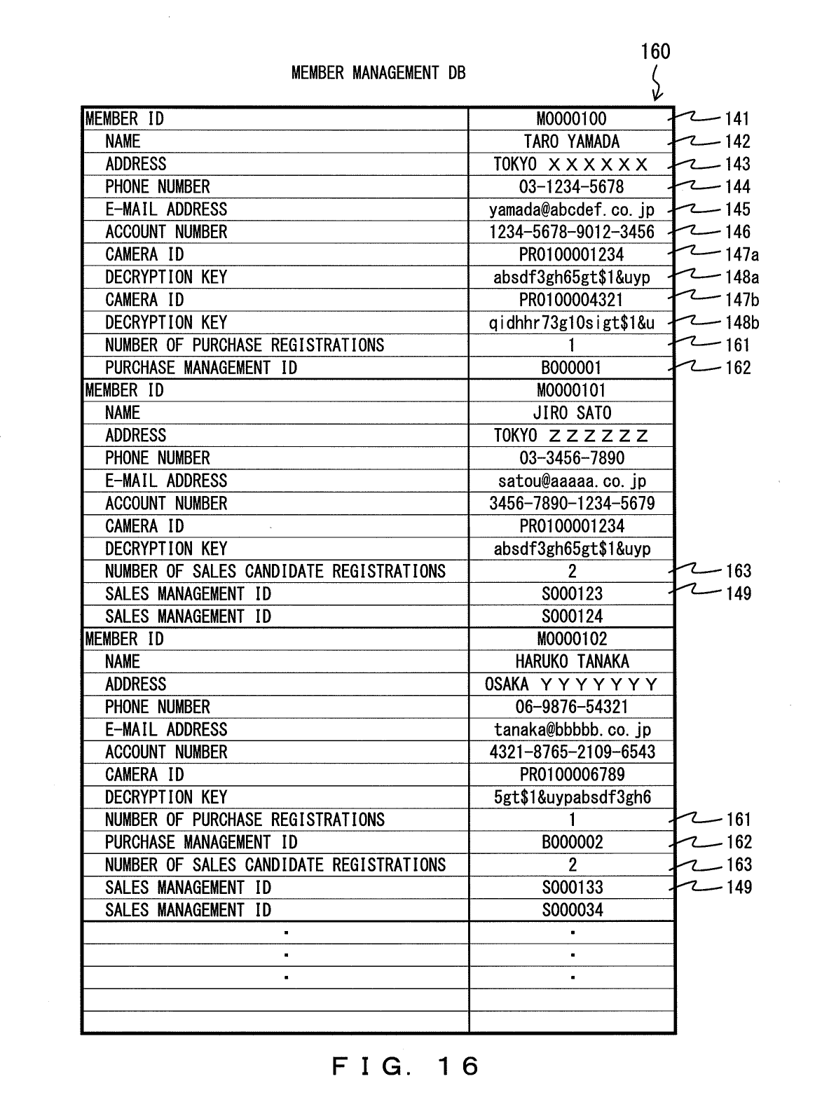

FIG. 16 is a conceptual diagram showing an example of configuration of a member management DB included in the server of the present third embodiment.

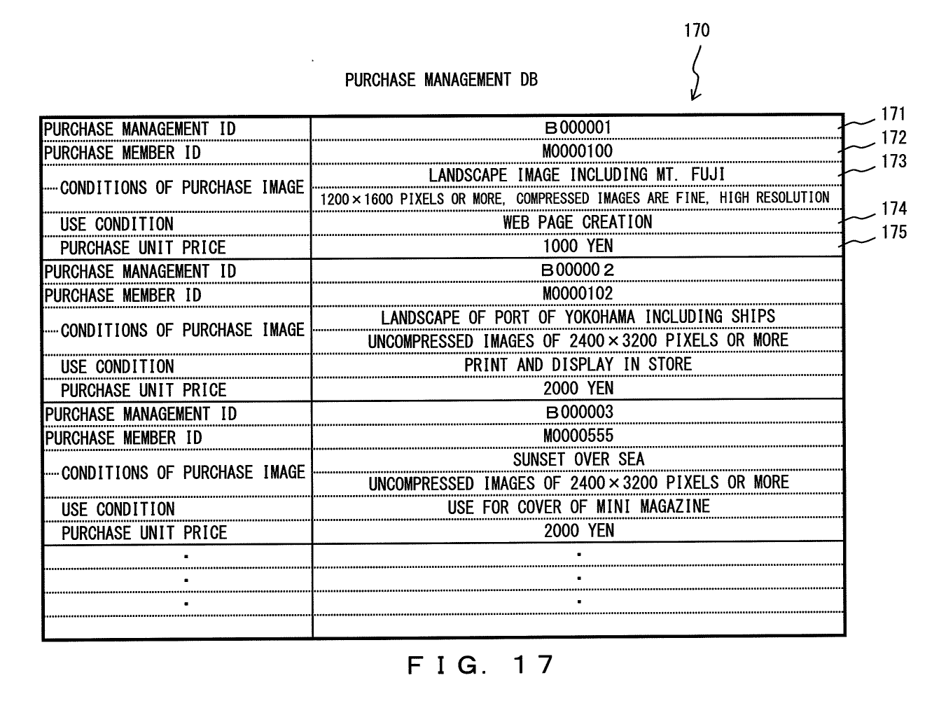

FIG. 17 is a conceptual diagram showing an example of configuration of a purchase management DB included in the server of the present third embodiment.

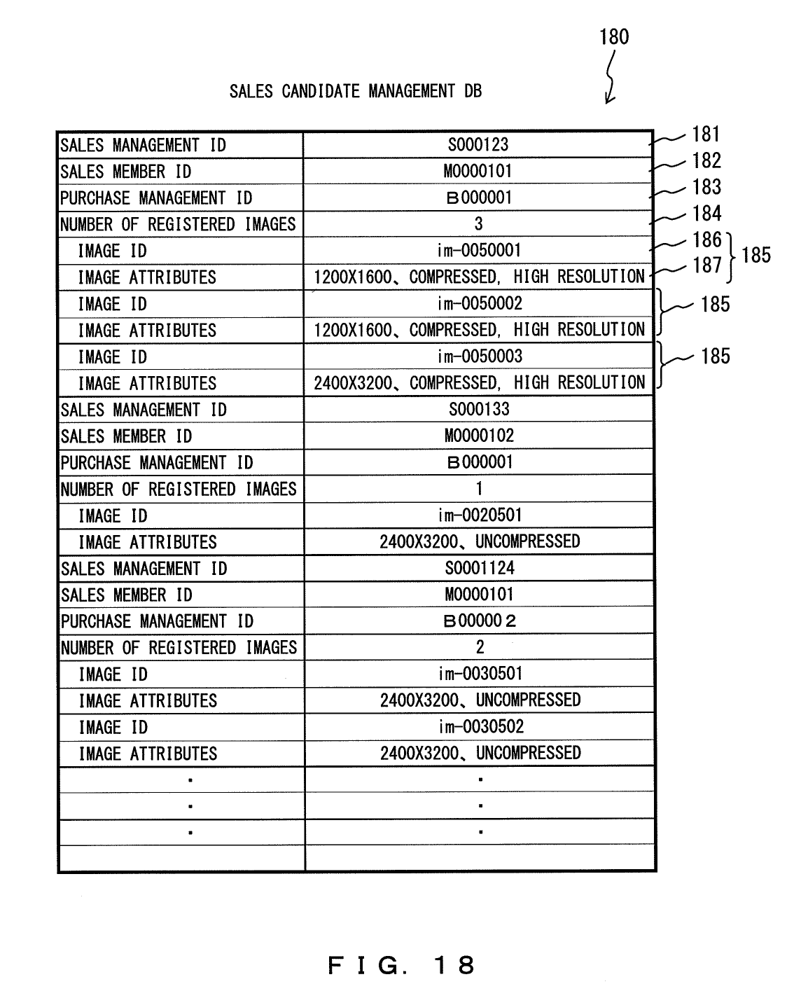

FIG. 18 is a conceptual diagram showing an example of configuration of a sales candidate management DB included in the server of the present third embodiment.

In the image data sales system S3 of the third embodiment, a service server 100A receives a purchase request of image data, such as photographs in desired conditions, from the information terminal 20, such as a personal computer, possessed by a registered member connected to the Internet 10. The service server 100A registers and discloses the purchase request to the member through the Internet.

An example will be illustrated, in which the member who possesses the camera 300 transmits a sales image disclosure request 50, which includes the photographed image data 36 according to purchase request conditions, to the service server 100A to disclose index images of the photographed image data 36 to the purchase requester to match the purchase request of image data in desired conditions with the sales of the photographed image data 36 by the owner of the camera 300 to thereby enable appropriate and efficient sales of the photographed image data 36 imaged by the camera 300.

Therefore, in the present third embodiment, the sales image disclosure request 50 transmitted from the camera 300 to the service server 100A includes a purchase management ID 37 for specifying a corresponding purchase request item as illustrated in FIG. 15.

The third embodiment illustrates an example, in which the image file 38 obtained by the camera 300 is stored in the information terminal 500, such as a personal computer, connected to the Internet 10, and the sales image disclosure request 50 including an image file 58 provided with the purchase management ID 37 is registered from the information terminal 500 to the service server 100A.

In the following description, the same configurations, etc., as in the first embodiment are designated with the same reference numerals, and the description will not be repeated.

The configuration of the service server 100A of the present third embodiment is almost the same as the configuration of the service server 100 of the first embodiment. The difference is that the member management DB 160, a purchase management DB 170, and a sales candidate management DB 180 are included to collect information of a purchase request related to image data from the member to manage and disclose the information.

It is the same as the member management DB 140 of the first embodiment that the member management DB 160 of the present third embodiment illustrated in FIG. 16 includes the fields from the member ID field 141 to the sales management ID field 149 to manage individual members. The member management DB 160 further includes a number of purchase request registrations field 161, a purchase management ID field 162, and a number of sales candidate registrations field 163.

The number of registrations of purchase request items, for which the member has indicated a purchase request of the photographed image data 36 in desired conditions and registered in the purchase management DB 170 described later, is registered in the number of purchase request registrations field 161.

Purchase management IDs for identifying individual purchase request items in the purchase management DB 170 described below are registered in the purchase management ID field 162.

For example, in the example of FIG. 16, a member with a member ID “M0000100” performs only the purchase registration, a member “M0000101” performs only the sales candidate registration, and a member “M0000102” performs both the purchase registration and the sales candidate registration.

The member specified by the member ID registered in the member ID field 141 transmits the sales image disclosure request 50 including the photographed image data 36 to the service server 100A, and the number of sales candidates registered in the sales candidate management database 180 is registered in the number of sales candidate registrations field.

For example, for the member specified by the member ID M0000101 of the member management DB 160 of FIG. 16, two sets of disclosed candidates, disclosed candidates including three images registered as sales management ID “S000123” and sales candidates including two images registered as sales management ID “S000124”, are disclosed to the purchase requester in the sales candidate management database 180 of FIG. 18.

The purchase management DB 170 in the present third embodiment illustrated in FIG. 17 is arranged to manage the purchase request items and is constituted by a purchase management ID field 171, a purchase member ID field 172, a purchase image condition field 173, a use condition field 174, and a purchase unit price field 175.

More specifically, purchase management IDs as unique information for identifying individual purchase request items are registered in the purchase management ID field 171. The member ID indicating the member who has registered the purchase request items is registered in the purchase member ID field 172. Desired conditions for the purchase request images are registered in the purchase image condition field 173. Information indicating the usage of the purchase request images is registered in the use condition field 174. The purchase request price is registered in the purchase unit price field 175.

As illustrated in FIG. 18, the sales candidate management DB 180 of the present embodiment is a database for matching and managing a purchase request and a sales request of image data. When the sales image disclosure request 50 is transmitted from a member who wishes to sell photographed images of the member, and the photographed image data 36 included in the sales image disclosure request 50 is authenticated as data that can be disclosed, the photographed image data, the member ID 31 of the member who wishes to sell the images, and information for identifying the purchase request items are registered in the database.

The sales candidate management DB 180 of the present third embodiment includes a sales management ID field 181, a sales member ID field 182, a purchase management ID field 183, a number of registered images field 184, and a registered image information field 185. Each registered image information field 185 includes an image ID field 186 and an image attribute field 187.

A sales management ID uniquely set to manage the sales request is registered in the sales management ID field 181 when a sales request is issued by a member specified by the sales member ID registered in the sales member ID field 182 in response to a purchase request specified by the purchase management ID registered in the purchase management ID field 183.

One or a plurality of photographed image data 36 are registered for one sales management ID. The individual photographed image data 36 are specified by the image IDs registered in the image ID field 186, and the attributes of the photographed image data 36 are registered in the image attribute field 187. One sales management ID corresponds to one sales image disclosure request 50, and attributes of the images included in the imaging configuration information 33 are registered in the image attribute field 187.

The program memory 121 includes a control program 131 in the present embodiment for the management using the databases, and the controller 110 executes the control program 131 to realize the following means.

More specifically, the controller 110 executes the control program 131 to register the camera ID 32 received through the network I/F 125 in the camera ID field 147X of the member management DB 160. The encryption key generation unit 126 generates the encryption key Ke and the decryption key Kd. The generated decryption key Kd is registered in the decryption key field 148X of the member management DB 160, and the generated encryption key Ke is transmitted to the camera 300 of the transmission source of the camera ID 32 through the network I/F 125. In this way, the control program 131 realizes imaging apparatus registration means.

The control program 131 further realizes purchase request item disclosure means for disclosing a list of image purchase request items registered in the purchase management DB 170 as a Web page on the Internet through the network I/F 125.

The control program 131 further realizes sales image data reception means for receiving the sales image disclosure request 50 from the camera 300 (or the information terminal 500) through the network I/F 125.

The control program 131 further realizes decryption means for decrypting the encrypted imaging configuration information 35 included in the image file 58 of the sales image disclosure request 50 received by the sales image data reception means by the decryption key Kd registered in the decryption key field 148X of the member management DB 160 specified by the member ID 31 and the camera ID 32, comparison means for comparing the imaging configuration information obtained by the decryption by the decryption means with the imaging configuration information 33 not encrypted included in the image file 58 of the received sales image disclosure request 50, and imaging condition determination means for determining whether the imaging configuration information 33 included in the image file 58 of the sales image disclosure request 50 satisfies the conditions of the purchase images registered in the purchase image condition field 173 of the purchase management DB 170 specified by the purchase management ID 37 included in the sales image disclosure request 50 and the image file 58 if the decrypted imaging configuration information coincides with the imaging configuration information not encrypted as a result of the comparison by the comparison means.

For example, conditions of purchase images “1200×1600 PIXELS OR MORE, COMPRESSED IMAGES ARE FINE, HIGH RESOLUTION” are registered in the purchase image condition field of the purchase request item specified by the purchase management ID B000001 registered in the purchase management DB 170 of FIG. 17. Meanwhile, if the camera 300 takes images at the pixel size of 1200×1600 pixels and in a high resolution mode, information “IMAGE SIZE=1200×1600, IMAGE QUALITY=HIGH RESOLUTION, STORAGE MODE=COMPRESSED” is included in the imaging configuration information 33 of the image file 58. If the service server 100A receives the sales image disclosure request 50 including the image file 58 transmitted from the camera 300, the imaging condition determination means of the control program 131 determines that the photographed image data 36 included in the image file 58 of the received sales image disclosure request 50 satisfies the purchase request items of the purchase management ID B000001.

To facilitate the process of the control program 131, conditions of purchase images may be selected and designated from predetermined items upon the input of the purchase request items.

A function of recognizing the subjects may be included in the control program 131. For example, whether the photographed image data 36 included in the image file 58 of the sales image disclosure request 50 includes Mt. Fuji of “LANDSCAPE IMAGES INCLUDING MT. FUJI” registered in the purchase image condition field 173 of the purchase management DB 170 can be determined by image recognition. If the camera 300 includes a GPS reception circuit not shown, position data during imaging outputted by the GPS reception circuit may be included in the imaging configuration information of the image file 58, and the positioning data may be used when the function of the control program 131 for recognizing the subjects determines whether photographed image data 36 satisfies the conditions registered in the purchase image condition field 173. For example, whether Mt. Fuji can be imaged from the imaging location can be determined from the positioning data corresponding to the photographed image data 36.

Meanwhile, the control program 131 realizes sales image data registration means for storing the sales image disclosure request 50 and the photographed image data 36 included in the image file 58 in the image memory 122 to generate an image ID for managing the photographed image and registering the generated image ID, the purchase management ID 37, and the imaging configuration information 33 in the image ID field 186, the purchase management ID field 183, and the image attribute field 187 of the sales candidate management DB 180, respectively.

The control program 351a in the camera 300 of the present third embodiment realizes the following means in addition to the means of the first embodiment.

More specifically, the controller 350 executes the control program 351a in the camera 300 of the present third embodiment to receive a Web page of purchase request from the camera 300 through the network I/F 380 and display the Web page as a purchase request item list on the display unit 330 to realize purchase request item display means.

The control program 351a of the present third embodiment further realizes purchase request item designation means for specifying a purchase request item designated by an operation of the user from the purchase request item list.

The control program 351a of the present third embodiment further realizes image disclosure request transmission means for setting, as the purchase management ID 37, the information registered in the purchase management ID field 171 for specifying the purchase request item designated by the purchase request item designation means in part of the image file 58 of the sales image disclosure request 50 as in FIG. 15 and transmitting the sales image data to the service server 100A through the network I/F 380.

The means realized by the control program 351a in the camera 300 of the present third embodiment are also included in the control program 510 of the information terminal 500 connected to the Internet 10 instead of the camera 300.

An operation of the present third embodiment will be described with reference to a flow chart.

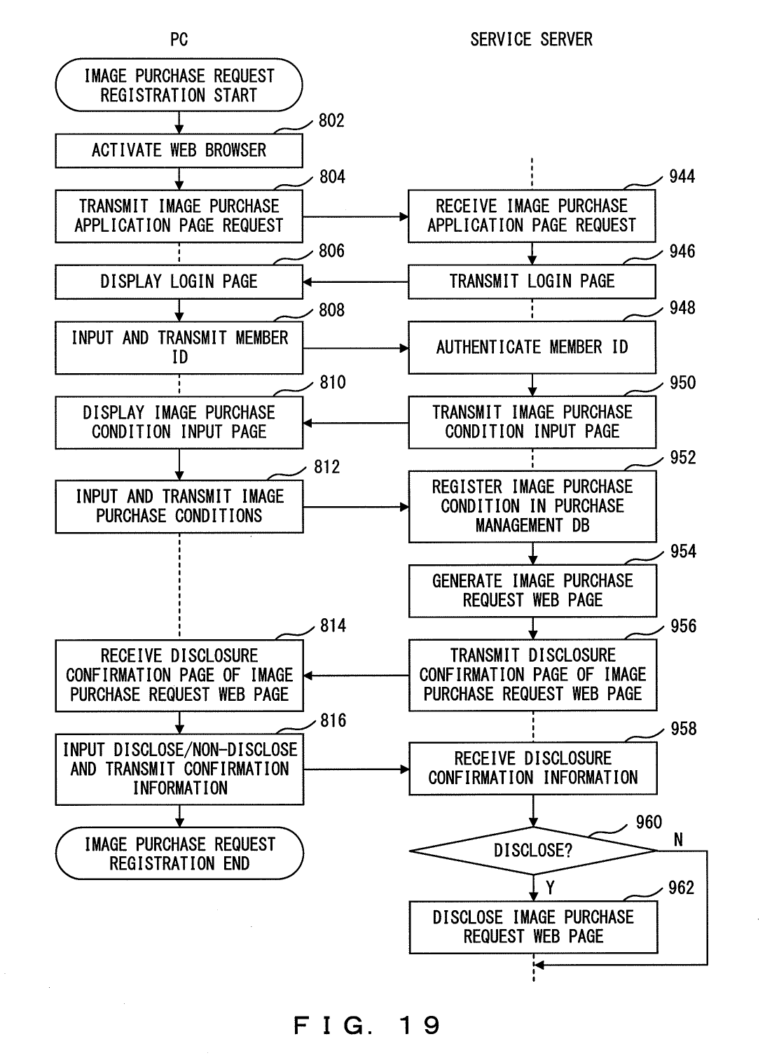

FIG. 19 is a flow chart showing an example of a registration process of a purchase request of image data from the information terminal 20 to the service server 100A according to the present embodiment.

When a member registered in the service server 100A registers a purchase request of image data from the information terminal 20 to the service server 100A, the information terminal 20 first activates a WEB browser for accessing the service server 100A (step 802) and transmits an image purchase application WEB page request to the service server 100A (step 804).

When the image purchase application Web page request is received (step 944), the service server 100A transmits a login WEB page to the information terminal 20 (step 946).

The information terminal 20 displays the login WEB page received from the service server 100A (step 806) and receives an input of the member ID from the purchase requester to transmit the member ID to the service server 100A (step 808).

After authenticating the member ID received from the information terminal 20 (step 948), the service server 100A transmits an image purchase condition input WEB page to the information terminal 20 (step 950).

The information terminal 20 displays the image purchase condition input WEB page received from the service server 100A (step 810) and receives an input of image purchase conditions from the user to transmit the conditions to the service server 100A (step 812).

After registering the image purchase conditions and the member ID of the purchase requester received from the information terminal 20 in the purchase management DB 170 (step 952), the service server 100A generates an image purchase request WEB page (step 954) and transmits a disclosure confirmation WEB page of the image purchase request WEB page to the information terminal 20 (step 956).

When the disclosure confirmation WEB page of the image purchase request WEB page is received from the service server 100A (step 814), the information terminal 20 receives an input of disclose/non-disclose by the user and transmits the input as confirmation information to the service server 100A (step 816).

When the disclosure confirmation information is received from the information terminal 20 (step 958), the service server 100A determines whether the instruction from the information terminal 20 allows the disclosure (step 960). If the disclosure is allowed, the service server 100A discloses the image purchase request WEB page on the Internet 10 (step 962).

This completes the registration of the purchase request of images from the information terminal 20 of the member to the service server 100A.

An example of an importing process of the image file 58 from the camera 300 to the information terminal 500 will be described.

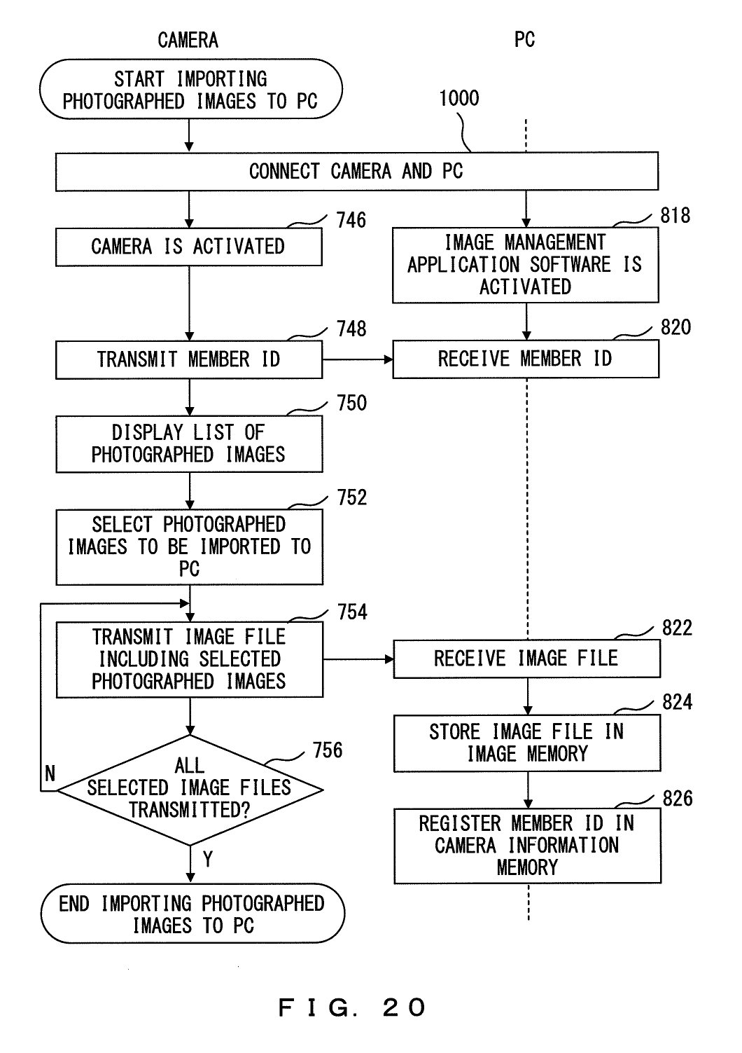

FIG. 20 is a flow chart showing an example of the importing process of sales image data from the camera 300 to the information terminal 500 in the image data sales system S3 of the present embodiment.

The controller 350 executes the control program 351a to realize the following operation of the camera 300. The processing unit 501 executes the control program 510 to realize the operation of the information terminal 500.

Upon the start of the importation of the photographed images to the information terminal 500, when the user connects the communication I/F 390 of the camera 300 with the communication I/F 504 of the information terminal 500 through a cable, etc. (step 1000), the camera 300 is activated, and the execution of the control program 351a is started (step 746). The information terminal 500 activates image management application software realized by the control program 510 (step 818).

The camera 300 reads out the member ID 31 from the camera ID memory 360 and transmits the member ID 31 to the information terminal 500 (step 748). The camera 300 displays the list of the photographed image data 36 on the display unit 330 (step 750) and makes the user select the image file 58 to be imported to the information terminal 500 (step 752).

The camera 300 transmits the image file 58 including the photographed image data 36 selected in step 752 and transmits the image file 58 to the information terminal 500 (steps 754 and 756).

The image memory 340 of the camera 300 already stores the image file 58 shown in FIG. 15 based on the imaging process of FIG. 12.

Meanwhile, after receiving the member ID 31 from the camera 300 (step 820), when the information terminal 500 further receives the image file 58 from the camera 300 (step 822), the information terminal 500 stores the received image file 58 in the image memory 503b (step 824) and stores the member ID 31 in the camera information memory 503c (step 826).

This completes the importation of the image file 58 from the camera 300 to the information terminal 500.

An example of a process of transmitting the image file 58 to be sold to the service server 100A and disclosing the image file 58 to the purchase requester in the information terminal 500 that has imported the image file 58 from the camera 300 will be described.

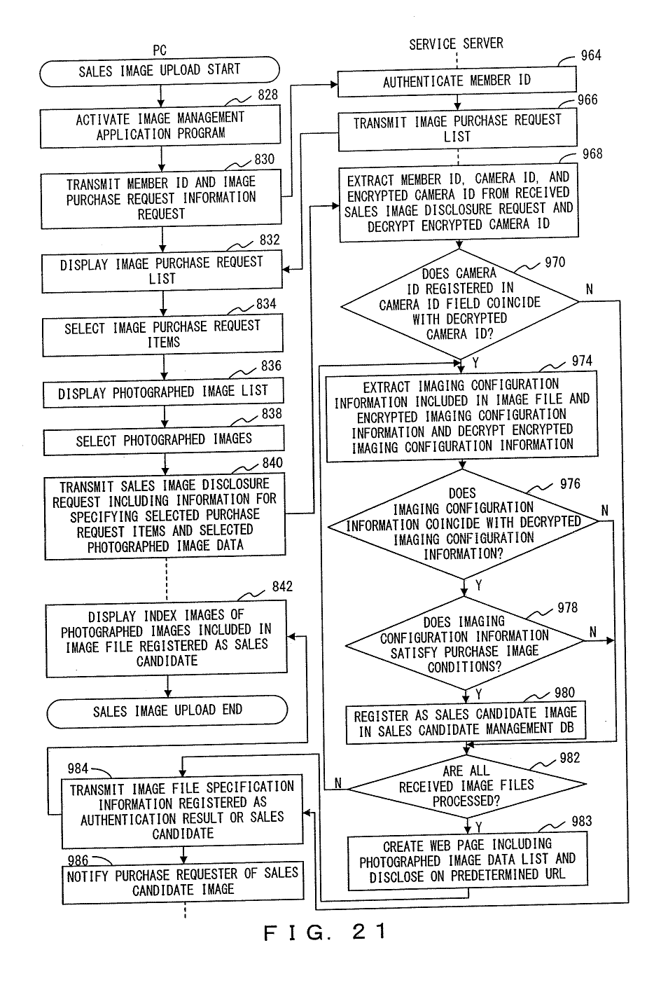

FIG. 21 is a flow chart describing an example of the process of transmitting the photographed image data of a sales candidate from the information terminal 500 to the service server 100A and disclosing a WEB page to the purchase requester in the image data sales system of the present embodiment.

Upon the start of the upload of the sales images, the information terminal 500 activates an image management application program as part of the control program 510 to start the process (step 828). The processing unit 501 executes the image management application program as part of the control program 510 to realize the following process of the information terminal 500.

The information terminal 500 transmits the member ID and the image purchase request information request to the service server 100A (step 830).

The service server 100A authenticates the member ID 31 received from the information terminal 500 (step 964) and transmits a list (image purchase request list) of the image purchase request information read out from the purchase management DB 170 to the information terminal 500 (step 966).

The information terminal 500 displays the image purchase request list received from the service server 100A on the display unit 505 (step 832) and makes the user select the image purchase request items (step 834).

The information terminal 500 further displays the list of the photographed image data 36 included in the image file 58 stored in the image memory 503b on the display unit 505 (step 836) and makes the user select the photographed image data of the sales candidate corresponding to the image purchase request item (step 838). The information terminal 500 creates the sales image disclosure request 50 including the member ID 31, the image file 58 including the selected photographed image data 36, and the purchase management ID 37 as information for specifying the selected purchase request item and transmits the request to the service server 100A (step 840).

The service server 100A reads out, from the member management DB 160, the decryption key Kd specified by the member ID 31 included in the sales image disclosure request 50 received from the information terminal 500 and the camera ID 32 read out from the image file 58 to decrypt the encrypted camera ID 34 of the image file 58 (step 968).

The service server 100A determines whether the camera ID registered in the camera ID field 147X of the member management DB 160 coincides with the camera ID decrypted from the encrypted camera ID 34 (step 970).

If the decrypted camera ID coincides with the camera ID registered in the camera ID field 147X, the service server 100A extracts the encrypted imaging configuration information 35 included in the image file 58 and decrypts the information by the decryption key Kd (step 974).

The service server 100A determines whether the imaging configuration information 33 included in the image file 58 coincides with the decrypted imaging configuration information (step 976). If the information coincides, the service server 100A further determines whether the imaging configuration information 33 satisfies the conditions of the purchase image registered in the purchase image condition field 173 of the purchase request item specified by the purchase management ID 37 (step 978). If the conditions are satisfied, the service server 100A stores the photographed image data 36 in the image memory 122 as a sales candidate image and registers the information for identifying the photographed image data and the imaging configuration information in the sales candidate management DB 180 (step 980).

The process of steps 974 to 980 is repeated for all image files 58 included in the sales image disclosure request 50 received from the information terminal 500 (step 982).

If step 982 is YES, index images of all photographed image data 36 registered as sales candidate items in the sales candidate management DB 180 in step 980 are generated, and a WEB page including all index images is created to disclose the WEB page on the URL designated for each member ID registered in the purchase member ID field 172 of the purchase management DB 170 (step 983).

If it is determined NO in step 970, steps of 974 to 983 are not executed.

The service server 100A transmits, to the information terminal 500, information indicating the photographed image data 36 disclosed to the purchase requester as sales candidates in the photographed image data 36 transmitted from the information terminal 500 to the service server 100A (step 984) and further transmits the URL of the WEB page created and disclosed in step 983 to the purchase requester specified by the member ID registered in the purchase member ID field 172 of the purchase management DB 170 through email, etc. (step 986).

On the other hand, the information terminal 500 displays the information transmitted from the service server 100A in step 984 on the display unit 505 (step 942).

In this way, according to the image data sales system S3 of the present third embodiment, the camera ID 32 included in the image file 58 and the encrypted camera ID 34 are compared, and the imaging configuration information 33 and the encrypted imaging configuration information 35 are compared. It can be verified that the photographed image data 36 requested for the purchase registered in the purchase management DB 170 is imaged by the camera 300 of the requesting member, and safe candidate images can be introduced to the purchase requester. Appropriate and smooth sales of the photographed image data 36 can be realized.

The candidate images that do not satisfy the conditions desired by the purchaser can be eliminated by comparing the imaging configuration information 33 and the conditions of the purchase images registered in the purchase image condition field 173. More appropriate and smooth sales of the photographed image data 36 can be realized.

It is obvious that the present invention is not limited to the configurations illustrated in the embodiments, and various changes can be made without departing from the scope of the present invention.

What is claimed is:

1. An image data sales system including a server apparatus that provides a service to a member through an information network and a camera registered in the server apparatus,
the camera comprising:
an imaging unit;
a camera ID memory that stores a camera ID for specifying the camera;
an encryption key memory that stores an encryption key distributed from the server apparatus by registering the camera ID in the server apparatus;
an image disclosure request generation unit that generates an image disclosure request including at least a member ID for identifying the member, image data imaged by the imaging unit, and an encrypted camera ID obtained by encrypting the camera ID by the encryption key stored in the encryption key memory; and
a first transmission unit that transmits the image disclosure request to the server apparatus through the information network,
the server apparatus comprising:
an encryption key generation unit that generates the encryption key and a corresponding decryption key corresponding to each camera ID of the camera registered by the member in the server apparatus;
a second transmission unit that transmits the generated encryption key to the camera with the registered camera ID;
a member management database that associates and registers at least the member ID, the camera ID of the camera registered by the member, and the decryption key generated by the encryption key generation unit;
an image disclosure determination unit that determines that the image data included in the image disclosure request can be disclosed if a second camera ID obtained by decrypting the encrypted camera ID included in the image disclosure request received from the camera through the information network by the decryption key registered in the member management database coincides with the camera ID registered in the member management database; and
an image disclosure unit that discloses the image data included in the image disclosure request determined to be able to be disclosed by the image disclosure determination unit as images to be sold through the information network.

2. The image data sales system according to claim 1, wherein
the image disclosure request generation unit of the camera further adds, to the image disclosure request, encrypted imaging configuration information, which is obtained by encrypting the imaging configuration information of the camera during imaging by the imaging unit by the encryption key distributed from the server apparatus, and the imaging configuration information not encrypted, and
the image disclosure determination unit of the server apparatus further determines that the image data included in the image disclosure request can be disclosed if the second imaging configuration information obtained by decrypting the encrypted imaging configuration information included in the image disclosure request by the decryption key coincides with the imaging configuration information not encrypted included in the image disclosure request.

3. The image data sales system according to claim 2, wherein
the server apparatus further comprises: a purchase request database for registering purchase request information including purchase conditions of image data from an image purchase requester received through the information network along with purchase request identification information for identifying the purchase request information; and
a purchase request disclosure unit that discloses the purchase request identification information and the purchase request information registered in the purchase request database through the information network,
the camera further comprises: a reception unit that receives the purchase request information registered in the purchase request database transmitted from the server apparatus through the information network; and
a selection unit that displays the purchase request information received by the reception unit to the user to receive a selection,
the image disclosure request generation unit of the camera adds the purchase request identification information of the purchase request information selected by the user in the selection unit to the image disclosure request, and
if the image disclosure determination unit of the server apparatus determines that the image data included in the image disclosure request attached with the purchase request identification information received from the camera can be disclosed, the image disclosure unit discloses the image data included in the image disclosure request to the image purchase requester specified by the purchase request identification information through the information network.

4. The image data sales system according to claim 3, wherein
if the second imaging configuration information obtained by decrypting the encrypted imaging configuration information included in the image disclosure request by the decryption key coincides with the imaging configuration information not encrypted included in the image disclosure request and if the imaging configuration information not encrypted included in the image disclosure request satisfies the purchase conditions of the image data included in the purchase request information specified by the purchase request identification information, the image disclosure determination unit discloses the image data included in the image disclosure request to the image purchase requester specified by the purchase request identification information through the information network.

5. The image data sales system according to claim 2, wherein
the camera comprises a terminal connection interface connected to an information terminal connected to the information network and is connected to the information network through the information terminal.

6. An image data sales method for selling image data imaged by a camera through a server apparatus that provides a service to a member, the image data sales method comprising:
a first step by the server apparatus generating a pair of an encryption key and a decryption key corresponding to the camera registered by the member, distributing the encryption key to the camera, and associating and registering the decryption key, a member ID for identifying the member, and a camera ID for identifying the camera in a member management database;
a second step by the camera transmitting, to the server apparatus, an image disclosure request including at least the member ID, image data obtained by imaging a subject, and an encrypted camera ID obtained by encrypting the camera ID by the encryption key; and
a third step by the server apparatus disclosing the image data included in the image disclosure request through an information network and registering the image data in a sales image database to set the image data as image data that can be sold if it is determined that a second camera ID obtained by decrypting the encrypted camera ID included in the image disclosure request by the decryption key registered in the member management database coincides with the camera ID registered in the member management database.

7. The image data sales method according to claim 6, wherein
in the second step, the camera further adds, to the image disclosure request, encrypted imaging configuration information, which is obtained by encrypting imaging configuration information of the camera during imaging by the encryption key distributed from the server apparatus in the first step, and the imaging configuration information not encrypted, and
in the third step, the server apparatus further determines whether second imaging configuration information obtained by decrypting the encrypted imaging configuration information by the decryption key coincides with the imaging configuration information not decrypted included in the image disclosure request, and if the information coincides, the server apparatus discloses the image data through the information network and resisters the image data in the sales image database to set the image data as image data that can be sold.

8. The image data sales method according to claim 7, wherein
the camera is connected to the server apparatus through an information terminal, and the image disclosure request is transmitted to the server apparatus through the information terminal.

9. An image data sales method for selling image data imaged by a camera through a server apparatus that provides a service to a member, the image data sales method comprising:
a first step by the server apparatus generating a pair of an encryption key and a decryption key corresponding to a camera ID for specifying the camera registered by the member, distributing the encryption key to the camera, and associating and registering the decryption key, a member ID for identifying the member, and the camera ID in a member management database;
a second step by the server apparatus receiving a registration of purchase request information including conditions of images to be purchased from an image purchase requester, storing the purchase request information in the purchase request database along with purchase request identification information for identifying the purchase request information, and disclosing the information through an information network that can be viewed from the camera;
a third step by the camera making a user select the disclosed purchase request information received from the server apparatus;
a fourth step by the camera transmitting, to the server apparatus, an image disclosure request including at least the purchase request identification information corresponding to the purchase request information selected by the user, the member ID, image data obtained by imaging a subject, and an encrypted camera ID obtained by encrypting the camera ID specific to the camera by the encryption key; and
a fifth step by the server apparatus disclosing the image data included in the image disclosure request to the image purchase requester specified by the purchase request identification information through the information network if it is determined that a second camera ID obtained by decrypting the encrypted camera ID included in the image disclosure request by the decryption key registered in the member management database coincides with the camera ID registered in the member management database.

10. The image data sales method according to claim 9, wherein
in the fourth step, the camera further adds, to the image disclosure request, encrypted imaging configuration information, which is obtained by encrypting imaging configuration information of the camera during imaging by the encryption key distributed from the server apparatus in the first step, and the imaging configuration information not encrypted, and
in the fifth step, the server apparatus further discloses the image data included in the image disclosure request to the image purchase requester specified by the purchase request identification information through the information network if it is determined that second imaging configuration information obtained by decrypting the encrypted imaging configuration information included in the image disclosure request by the decryption key registered in the member management database coincides with the imaging configuration information not encrypted included in the image disclosure request.

11. The image data sales method according to claim 10, wherein
in the fifth step, the server apparatus discloses the image data included in the image disclosure request to the image purchase requester specified by the purchase request identification information through the information network if it is determined that the second imaging configuration information coincides with the imaging configuration information not encrypted included in the image disclosure request and if the imaging configuration information satisfies conditions of images to be purchased included in the purchase request information.

12. The image data sales method according to claim 10, wherein
the camera is connected to the server apparatus through an information terminal, and the image disclosure request is transmitted to the server apparatus through the information terminal.

13. A camera that is connected to a server apparatus, which provides a service to a member, through an information network to form an image data sales system, the camera comprising:
a communication unit that transmits and receives information to and from the server apparatus;
an image pickup unit that images a subject to output image data;
an identification information memory that stores a camera ID for specifying the camera;
an encryption key memory that stores an encryption key generated corresponding to the camera ID received from the server apparatus through the communication unit;
an encryption unit that encrypts the camera ID by the encryption key to generate an encrypted camera ID;
an image disclosure request generation unit that generates an image disclosure request including at least a member ID for specifying the member, the image data, and the encrypted camera ID; and
an image disclosure request transmission unit that transmits the image disclosure request to the server apparatus through the communication unit.

14. The camera according to claim 13, wherein
the image pickup unit outputs imaging configuration information during imaging,
the encryption unit encrypts the imaging configuration information by the encryption key to generate encrypted imaging configuration information, and
the image disclosure request generation unit further adds, to the image disclosure request, the encrypted imaging configuration information and the imaging configuration information not encrypted.

15. The camera according to claim 14, further comprising:
a purchase request information display unit that displays purchase request information received from the server apparatus by the communication unit on a display; and
a purchase request designation unit that designates a piece of purchase request information displayed on the display by an operation of a user, wherein
the image disclosure request transmission unit adds, to the image disclosure request, purchase request identification information for specifying the purchase request information designated by the purchase request designation unit to transmit the image disclosure request to the server apparatus.

16. The camera according to claim 14, further comprising
a second communication unit that is connected to an information terminal apparatus, wherein
the camera is connected to the information terminal apparatus connected to the server apparatus through the second communication unit and is connected to the server apparatus through the information terminal apparatus.

17. A server apparatus that provides a service to a member and that forms an image data sales system when a camera of the member is connected through an information network, the server apparatus comprising:
a communication unit that transmits and receives information to and from the camera;
a sales image database for registering image data to be sold transmitted from the camera;
an encryption key generation unit that generates an encryption key and a decryption key corresponding to a camera ID for specifying the camera transmitted from the camera and received through the communication unit;
a member management database that registers a member ID for identifying the member, a camera ID for identifying the camera, and a decryption key generated by the encryption key generation unit corresponding to the camera ID;
a camera registration unit that distributes the encryption key generated by the encryption key generation unit to the camera of a transmission source of the camera ID through the communication unit;
an image disclosure request reception unit that receives an image disclosure request including at least the member ID, the image data imaged by the camera, and an encrypted camera ID obtained by encrypting the camera ID by the encryption key through the communication unit;
a sales image data registration unit that registers the image data included in the image disclosure request in the sales image database if it is determined that a second camera ID obtained by decrypting the encrypted camera ID included in the image disclosure request by the decryption key registered in the member management database coincides with the camera ID registered in the member management database; and
a sales image disclosure unit that discloses the image data registered in the sales image database through the communication unit.

18. The server apparatus according to claim 17, wherein
the image disclosure request reception unit receives the image disclosure request further including encrypted imaging configuration information obtained by encrypting imaging configuration information of the camera related to the image data by the encryption key and including the imaging configuration information not encrypted, and
the sales image data registration unit further registers the image data included in the image disclosure request in the sales image database if it is determined that second imaging configuration information obtained by decrypting the encrypted imaging configuration information included in the image disclosure request by the decryption key registered in the member management database coincides with the imaging configuration information not encrypted included in the image disclosure request.

19. The server apparatus according to claim 18, further comprising
a purchase request database including purchase conditions of the image data registered along with purchase request identification information, for each image purchase request of a purchase requester;
a purchase request disclosure unit that discloses a list of the image purchase requests registered in the purchase request database through the communication unit; and
a candidate image disclosure unit that notifies the purchase requester of candidate image data, wherein
the sales image data registration unit has
a function of disclosing, through the candidate image disclosure unit, the image data included in the image disclosure request to an image purchase requester specified by the purchase request identification information if it is determined that image data included in the received image disclosure request can be registered in the sales image database and if the imaging configuration information included in the image disclosure request satisfies the purchase conditions of the purchase request specified by the purchase request identification information included in the image disclosure request.
